(19) United States
(12) Patent Application Publication
(10) Pub. No.: US 2025/0212125 A1
(43) Pub. Date: Jun. 26, 2025

(54) WAVEFORM ENHANCEMENT IN BACKSCATTER COMMUNICATIONS

(71) Applicant: QUALCOMM INCORPORATED, San Diego, CA (US)

(72) Inventors: Kangqi Liu, San Diego, CA (US); Chao Wei, Beijing (CN); Min Huang, Beijing (CN); Mingxi Yin, Beijing (CN); Rui Hu, Beijing (CN); Hao Xu, Beijing (CN)

(21) Appl. No.: 18/851,966

(22) PCT Filed: Jun. 7, 2022
(86) PCT No.: PCT/CN2022/097280

§ 371 Date: Sep. 27, 2024

(51) Int. Cl. H04W 52/02; H02J 50/00; H04B 1/69

(52) U.S. Cl. CPC H04W 52/0235; H04B 1/69; H02J 50/001; H04B 2001/6912

(57) ABSTRACT

Methods, systems, and devices for wireless communications are described. A passive user equipment (UE) may transmit a modulated chirp spread spectrum (CSS) wave over a backscatter link to a receiving device. A source device may transmit a power-up wave signal to the UE, which may provide the UE with power to perform backscatter communications. The source device or the receiving device may provide the UE with a frequency shift assignment to use during data modulation. The UE may modulate an upchirp symbol using frequency shift keying (FSK). When multiple passive UEs are concurrently communicating with the receiving device each UE may be assigned a different baseband frequency shift. Each UE may perform modulation using on-off keying (OOK) with FSK. The receiving device may receive the backscattered modulated CSS wave and de-spread the wave. The receiving device may identify each UE by its frequency shift.

### CROSS REFERENCE

The present application is a 371 national stage filing of International PCT Application No. PCT/CN2022/097280 by Liu et al. entitled “WAVEFORM ENHANCEMENT IN BACKSCATTER COMMUNICATIONS,” filed Jun. 7, 2022, which is assigned to the assignee hereof, and which is expressly incorporated by reference in its entirety herein.

### TECHNICAL FIELD

The following relates to wireless communications, including waveform enhancement in backscatter communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

A wireless communications system may include one or more passive devices that communicate with a source device and a receiver device. The source device may provide power to the passive devices for the passive devices to perform communications.

### SUMMARY

The described techniques relate to improved methods, systems, devices, and apparatuses that support waveform enhancement in backscatter communications. For example, the described techniques provide for implementations of a passive user equipment (UE) into a wireless communications system. To support a passive UE, a transmitter device, such as a UE or a network entity, may configure the passive UE with a base band frequency shift that the passive UE is to use to encode passive UE data onto a received power up signal. The received power up signal may be in the form of a chirp spread spectrum (CSS) wave or the passive UE may use a CSS wave to encode the data on to a carrier.

A method for wireless communications at a passive user equipment (UE) is described. The method may include receiving signaling indicating a baseband frequency shift that the passive UE is to use for one or more backscatter communications, receiving, from a source device, a power-up wave signal including a first radio frequency wave pattern, and signaling, to a receiver device, the one or more backscatter communications by frequency shifting the power-up wave signal according to the indicated baseband frequency shift and using a second radio frequency wave pattern, where one of the first radio frequency wave pattern or the second radio frequency wave pattern includes a chirp spread spectrum pattern.

An apparatus for wireless communications at a passive UE is described. The apparatus may include at least one processor and memory coupled with the at least one processor, the memory storing instructions executable by the at least one processor to cause the passive UE to receive signaling indicating a baseband frequency shift that the passive UE is to use for one or more backscatter communications, receive, from a source device, a power-up wave signal including a first radio frequency wave pattern, and signal, to a receiver device, the one or more backscatter communications by frequency shifting the power-up wave signal according to the indicated baseband frequency shift and using a second radio frequency wave pattern, where one of the first radio frequency wave pattern or the second radio frequency wave pattern includes a chirp spread spectrum pattern.

Another apparatus for wireless communications at a passive UE is described. The apparatus may include means for receiving signaling indicating a baseband frequency shift that the passive UE is to use for one or more backscatter communications, means for receiving, from a source device, a power-up wave signal including a first radio frequency wave pattern, and means for signaling, to a receiver device, the one or more backscatter communications by frequency shifting the power-up wave signal according to the indicated baseband frequency shift and using a second radio frequency wave pattern, where one of the first radio frequency wave pattern or the second radio frequency wave pattern includes a chirp spread spectrum pattern.

A non-transitory computer-readable medium storing code for wireless communications at a passive UE is described. The code may include instructions executable by at least one processor to receive signaling indicating a baseband frequency shift that the passive UE is to use for one or more backscatter communications, receive, from a source device, a power-up wave signal including a first radio frequency wave pattern, and signal, to a receiver device, the one or more backscatter communications by frequency shifting the power-up wave signal according to the indicated baseband frequency shift and using a second radio frequency wave pattern, where one of the first radio frequency wave pattern or the second radio frequency wave pattern includes a chirp spread spectrum pattern.

Some examples of the method, apparatuses, and non-transitory computer-readable medium described herein may further include operations, features, means, or instructions for signaling, to the receiver device, an indication that an amount of power received via the power-up wave signal satisfies a received power threshold.

In some examples of the method, apparatuses, and non-transitory computer-readable medium described herein, receiving the signaling indicating the baseband frequency shift may include operations, features, means, or instructions for receiving the signaling based on a satisfaction of a received power threshold via power received via the power-up wave signal.

In some examples of the method, apparatuses, and non-transitory computer-readable medium described herein, receiving the signaling indicating the baseband frequency shift may include operations, features, means, or instructions for receiving an indication of a frequency shift value that the passive UE may be to use for the one or more backscatter communications.

In some examples of the method, apparatuses, and non-transitory computer-readable medium described herein, signaling the one or more backscatter communications may include operations, features, means, or instructions for modulating a first value of data of the one or more backscatter communications using the frequency shift value and a second value of data of the one or more backscatter communications without using the frequency shift value.

In some examples of the method, apparatuses, and non-transitory computer-readable medium described herein, receiving the signaling indicating the baseband frequency shift may include operations, features, means, or instructions for receiving an indication of a first frequency shift value and a second frequency shift value that the passive UE may be to use for the one or more backscatter communications.

In some examples of the method, apparatuses, and non-transitory computer-readable medium described herein, signaling the one or more backscatter communications may include operations, features, means, or instructions for modulating a first value of data of the one or more backscatter communications using the first frequency shift value and a second value of data of the one or more backscatter communications using the second frequency shift value.

In some examples of the method, apparatuses, and non-transitory computer-readable medium described herein, receiving the signaling indicating the baseband frequency shift may include operations, features, means, or instructions for receiving an indication of an identifier associated with the passive UE, where the baseband frequency shift may be determined based on the identifier.

Some examples of the method, apparatuses, and non-transitory computer-readable medium described herein may further include operations, features, means, or instructions for receiving, from the source device, signaling indicating that the passive UE may be to signal the one or more backscatter communications, where the UE signals the one or more backscatter communications based on receiving the signaling.

In some examples of the method, apparatuses, and non-transitory computer-readable medium described herein, signaling the one or more backscatter communications may include operations, features, means, or instructions for modulating data of the one or more backscatter communications by frequency shifting the power-up wave signal in accordance with the baseband frequency shift and using the second radio frequency wave pattern.

In some examples of the method, apparatuses, and non-transitory computer-readable medium described herein, the first radio frequency wave pattern includes a chirp spread spectrum wave and the second radio frequency wave pattern includes a square wave.

In some examples of the method, apparatuses, and non-transitory computer-readable medium described herein, the first radio frequency wave pattern includes a carrier wave and the second radio frequency wave pattern includes a chirp spread spectrum square wave.

In some examples of the method, apparatuses, and non-transitory computer-readable medium described herein, the source device may be a network entity and the receiver device may be a UE, or the source device may be the UE and the receiver device may be the network entity, the source device may be a first network entity and the receiver device may be a second network entity, the source device may be a first UE and the receiver device may be a second UE, the source device and the receiver device may be the UE, or the source device and the receiver device may be the network entity.

A method for wireless communications at a source device is described. The method may include transmitting, to a passive UE, signaling indicating a baseband frequency shift that the passive UE is to use for one or more backscatter communications and transmitting, to the passive UE, a power-up wave signal including a first radio frequency wave pattern, where the passive UE is configured to signal the one or more backscatter communications by frequency shifting the power-up wave signal according to the indicated baseband frequency shift and using a second radio frequency wave pattern, where one of the first radio frequency wave pattern or the second radio frequency wave pattern includes a chirp spread spectrum pattern.

An apparatus for wireless communications at a source device is described. The apparatus may include at least one processor and memory coupled with the at least one processor, the memory storing instructions executable by the at least one processor to cause the source device to transmit, to a passive UE, signaling indicating a baseband frequency shift that the passive UE is to use for one or more backscatter communications and transmit, to the passive UE, a power-up wave signal including a first radio frequency wave pattern, where the passive UE is configured to signal the one or more backscatter communications by frequency shifting the power-up wave signal according to the indicated baseband frequency shift and using a second radio frequency wave pattern, where one of the first radio frequency wave pattern or the second radio frequency wave pattern includes a chirp spread spectrum pattern.

Another apparatus for wireless communications at a source device is described. The apparatus may include means for transmitting, to a passive UE, signaling indicating a baseband frequency shift that the passive UE is to use for one or more backscatter communications and means for transmitting, to the passive UE, a power-up wave signal including a first radio frequency wave pattern, where the passive UE is configured to signal the one or more backscatter communications by frequency shifting the power-up wave signal according to the indicated baseband frequency shift and using a second radio frequency wave pattern, where one of the first radio frequency wave pattern or the second radio frequency wave pattern includes a chirp spread spectrum pattern.

A non-transitory computer-readable medium storing code for wireless communications at a source device is described. The code may include instructions executable by at least one processor to transmit, to a passive UE, signaling indicating a baseband frequency shift that the passive UE is to use for one or more backscatter communications and transmit, to the passive UE, a power-up wave signal including a first radio frequency wave pattern, where the passive UE is configured to signal the one or more backscatter communications by frequency shifting the power-up wave signal according to the indicated baseband frequency shift and using a second radio frequency wave pattern, where one of the first radio frequency wave pattern or the second radio frequency wave pattern includes a chirp spread spectrum pattern.

Some examples of the method, apparatuses, and non-transitory computer-readable medium described herein may further include operations, features, means, or instructions for receiving, from a network entity, an indication to transmit the power-up wave signal.

Some examples of the method, apparatuses, and non-transitory computer-readable medium described herein may further include operations, features, means, or instructions for receiving, from a network entity, signaling indicating the first radio frequency wave pattern.

Some examples of the method, apparatuses, and non-transitory computer-readable medium described herein may further include operations, features, means, or instructions for receiving, from a network entity, an indication to terminate transmission of the power-up wave signal and stopping transmission of the power-up wave signal based on receiving the indication to terminate transmission.

Some examples of the method, apparatuses, and non-transitory computer-readable medium described herein may further include operations, features, means, or instructions for receiving, from a network entity, signaling indicating the baseband frequency shift that the passive UE may be to use for one or more backscatter communications, where the signaling indicating the baseband frequency shift may be transmitted to the passive UE based on receiving the signaling indicating the baseband frequency shift.

Some examples of the method, apparatuses, and non-transitory computer-readable medium described herein may further include operations, features, means, or instructions for receiving, from a network entity, an indication that the passive UE may be to signal the one or more backscatter communications, where the power-up wave signal may be transmitted based on receiving the indication.

Some examples of the method, apparatuses, and non-transitory computer-readable medium described herein may further include operations, features, means, or instructions for transmitting, to the passive UE based on receiving the indication that the passive UE may be to signal, an indication that the passive UE may be to signal the one or more backscatter communications.

Some examples of the method, apparatuses, and non-transitory computer-readable medium described herein may further include operations, features, means, or instructions for transmitting, to a second UE, signaling indicating the baseband frequency shift that the passive UE may be to use for the one or more backscatter communications.

Some examples of the method, apparatuses, and non-transitory computer-readable medium described herein may further include operations, features, means, or instructions for receiving, from a second UE, signaling indicating that an amount of power received, at the passive UE, via the power-up wave signal satisfies a received power threshold, where the signaling indicating the baseband frequency shift may be transmitted based at least on the amount of power satisfying the received power threshold.

In some examples of the method, apparatuses, and non-transitory computer-readable medium described herein, transmitting the signaling indicating the baseband frequency shift may include operations, features, means, or instructions for transmitting an indication of a frequency shift value that the passive UE may be to use for the one or more backscatter communications.

In some examples of the method, apparatuses, and non-transitory computer-readable medium described herein, transmitting the signaling indicating the baseband frequency shift may include operations, features, means, or instructions for transmitting an indication of a first frequency shift value and a second frequency shift value that the passive UE may be to use for the one or more backscatter communications.

In some examples of the method, apparatuses, and non-transitory computer-readable medium described herein, transmitting the signaling indicating the baseband frequency shift may include operations, features, means, or instructions for transmitting an indication of a identifier associated with the passive UE.

In some examples of the method, apparatuses, and non-transitory computer-readable medium described herein, transmitting the signaling indicating the baseband frequency shift may include operations, features, means, or instructions for transmitting the identifier associated with the first passive UE and an identifier associated with a second passive UE.

Some examples of the method, apparatuses, and non-transitory computer-readable medium described herein may further include operations, features, means, or instructions for transmitting, to the passive UE, a second UE, or both, signaling indicating that the passive UE may be to signal the one or more backscatter communications.

In some examples of the method, apparatuses, and non-transitory computer-readable medium described herein, the source device may be a network entity or a UE.

A method for wireless communications at a receiver device is described. The method may include receiving, from the passive UE, signaling including encoded data of the one or more backscatter communications and decoding the encoded data of the one or more backscatter communications based on a baseband frequency shift associated with communications by the passive UE.

An apparatus for wireless communications at a receiver device is described. The apparatus may include at least one processor and memory coupled with the at least one processor, the memory storing instructions executable by the at least one processor to cause the receiver device to receive, from the passive UE, signaling including encoded data of the one or more backscatter communications and decode the encoded data of the one or more backscatter communications based on a baseband frequency shift associated with communications by the passive UE.

Another apparatus for wireless communications at a receiver device is described. The apparatus may include means for receiving, from the passive UE, signaling including encoded data of the one or more backscatter communications and means for decoding the encoded data of the one or more backscatter communications based on a baseband frequency shift associated with communications by the passive UE.

A non-transitory computer-readable medium storing code for wireless communications at a receiver device is described. The code may include instructions executable by at least one processor to receive, from the passive UE, signaling including encoded data of the one or more backscatter communications and decode the encoded data of the one or more backscatter communications based on a baseband frequency shift associated with communications by the passive UE.

Some examples of the method, apparatuses, and non-transitory computer-readable medium described herein may further include operations, features, means, or instructions for transmitting, to a source device, signaling indicating that the source device may be to transmit a power-up wave signal including a first radio frequency wave pattern.

Some examples of the method, apparatuses, and non-transitory computer-readable medium described herein may further include operations, features, means, or instructions for receiving, from the passive UE, signaling indicating that an amount of power received via a power-up wave signal satisfies a received power threshold, where the signaling indicating the baseband frequency shift may be transmitted based on the signaling indicating that the amount of power satisfies the received power threshold.

Some examples of the method, apparatuses, and non-transitory computer-readable medium described herein may further include operations, features, means, or instructions for transmitting, to a network entity, signaling indicating that the amount of power received, by the passive UE, satisfies the received power threshold.

In some examples of the method, apparatuses, and non-transitory computer-readable medium described herein, transmitting the signaling indicating the baseband frequency shift may include operations, features, means, or instructions for transmitting the signaling indicating a frequency shift value that the passive UE may be to use for the one or more backscatter communications.

In some examples of the method, apparatuses, and non-transitory computer-readable medium described herein, transmitting the signaling indicating the baseband frequency shift may include operations, features, means, or instructions for transmitting the signaling indicating a first frequency shift value and a second frequency shift value that the passive UE may be to use for the one or more backscatter communications.

In some examples of the method, apparatuses, and non-transitory computer-readable medium described herein, transmitting the signaling indicating the baseband frequency shift may include operations, features, means, or instructions for transmitting the signaling indicating a identifier associated with the passive UE.

Some examples of the method, apparatuses, and non-transitory computer-readable medium described herein may further include operations, features, means, or instructions for transmitting, to a source device, signaling indicating that the source device may be to terminate transmission of a power-up wave signal.

Some examples of the method, apparatuses, and non-transitory computer-readable medium described herein may further include operations, features, means, or instructions for receiving, from a network entity, signaling indicating the baseband frequency shift that the passive UE may be to use for one or more backscatter communications, where the signaling may be transmitted to the passive UE based on receiving the signaling from the network entity.

Some examples of the method, apparatuses, and non-transitory computer-readable medium described herein may further include operations, features, means, or instructions for receiving, from a network entity, signaling indicating that the receiver device may be to receive the one or more backscatter communications.

Some examples of the method, apparatuses, and non-transitory computer-readable medium described herein may further include operations, features, means, or instructions for transmitting, to a network entity, signaling that includes the data of the one or more backscatter communications.

In some examples of the method, apparatuses, and non-transitory computer-readable medium described herein, the receiver device may be a network entity or a UE.

In some examples of the method, apparatuses, and non-transitory computer-readable medium described herein, the data of the one or more backscatter communications may be encoded using a chirp spread spectrum pattern.

### BRIEF DESCRIPTION OF THE DRAWINGS

FIG. 1 illustrates an example of a wireless communications system that supports waveform enhancement in backscatter communications in accordance with one or more aspects of the present disclosure.

FIG. 2 illustrates an example of a communications system that supports waveform enhancement in backscatter communications in accordance with one or more aspects of the present disclosure.

FIG. 3 illustrates an example of a chirp spread spectrum (CSS) modulation that supports waveform enhancement in backscatter communications in accordance with one or more aspects of the present disclosure.

FIG. 4 illustrates an example of a CSS modulation that supports waveform enhancement in backscatter communications in accordance with one or more aspects of the present disclosure.

FIG. 5 illustrates an example of a process flow that supports waveform enhancement in backscatter communications in accordance with one or more aspects of the present disclosure.

FIG. 6 illustrates an example of a process flow that supports waveform enhancement in backscatter communications in accordance with one or more aspects of the present disclosure.

FIGS. 7 and 8 show block diagrams of devices that support waveform enhancement in backscatter communications in accordance with one or more aspects of the present disclosure.

FIG. 9 shows a block diagram of a communications manager that supports waveform enhancement in backscatter communications in accordance with one or more aspects of the present disclosure.

FIG. 10 shows a diagram of a system including a device that supports waveform enhancement in backscatter communications in accordance with one or more aspects of the present disclosure.

FIGS. 11 and 12 show block diagrams of devices that support waveform enhancement in backscatter communications in accordance with one or more aspects of the present disclosure.

FIG. 13 shows a block diagram of a communications manager that supports waveform enhancement in backscatter communications in accordance with one or more aspects of the present disclosure.

FIG. 14 shows a diagram of a system including a device that supports waveform enhancement in backscatter communications in accordance with one or more aspects of the present disclosure.

FIGS. 15 through 20 show flowcharts illustrating methods that support waveform enhancement in backscatter communications in accordance with one or more aspects of the present disclosure.

### DETAILED DESCRIPTION

Some wireless communications systems may implement one or more passive user equipments (UEs). A passive UE may operate on little or no battery power and instead may rely on radio frequency (RF) signals to provide power for performing data communications with an active device. For example, the UE may use a received signal to power integrated circuitry for modulating a data signal. Accordingly, the passive UE may utilize backscattering techniques, meaning that the UE may modulate data on a signal received from another device and reflect the received wave to a receiving device (e.g., network entity, base station, or another UE). The receiving device may receive and decode the backscattered message. However, backscattering techniques may be susceptible to low signal to interference and noise ratio (SINR), fading, and in-band interference. As such, communications from a passive UE may not be reliable.

Passive UEs may be used in various implementations. In one example, a passive UE may be implemented as an industrial sensor in which replacing a battery may be prohibitively difficult or undesirable (e.g., for safety monitoring or fault detection in smart factories, infrastructures, or environments). In another example, a passive UE may be implemented in smart logistics or warehouses because such environments may be extremely-low cost, small in size, maintenance free, durable, and have a long lifespan (e.g., automated asset management in factories replacing RF identifier (RFID)). In some examples, a passive UE may be used in a smart home network for household items management, wearables, and environment monitoring (e.g., wearable for medical monitoring where patients do not replace battery themselves).

The techniques, methods, and apparatuses described herein provide for increased reliability in backscattering performed by a passive UE. Specifically, the UE may generate a modulated chirp spread spectrum (CSS) wave from a received power-up signal. For example, the UE may signal one or more backscatter communications by frequency shifting a power-up signal by a baseband frequency shift. In one implementation, the RF source that transmits the power-up signal may be another UE while the information receiving device may be a network entity. In another implementation, the RF source may be a network entity and the information receiving device may be another UE. The devices may utilize various signaling techniques to configure the passive UE with the baseband frequency shift and to initiate backscatter communications. These and other techniques are described in further detail with respect to the figures.

Particular implementations of the subject matter described in this disclosure can be implemented to realize one or more of the following potential advantages. The described techniques may support improvements in receiver sensitivity as well as increased resilience to fading and in-band interference. The techniques may also lead to increased data rate gain and power gain compared to other backscattering methods.

Aspects of the disclosure are initially described in the context of wireless communications systems. An additional wireless communications system, CSS modulation schemes, and process flows are then provided to describe aspects of the disclosure. Aspects of the disclosure are further illustrated by and described with reference to apparatus diagrams, system diagrams, and flowcharts that relate to waveform enhancement in backscatter communications.

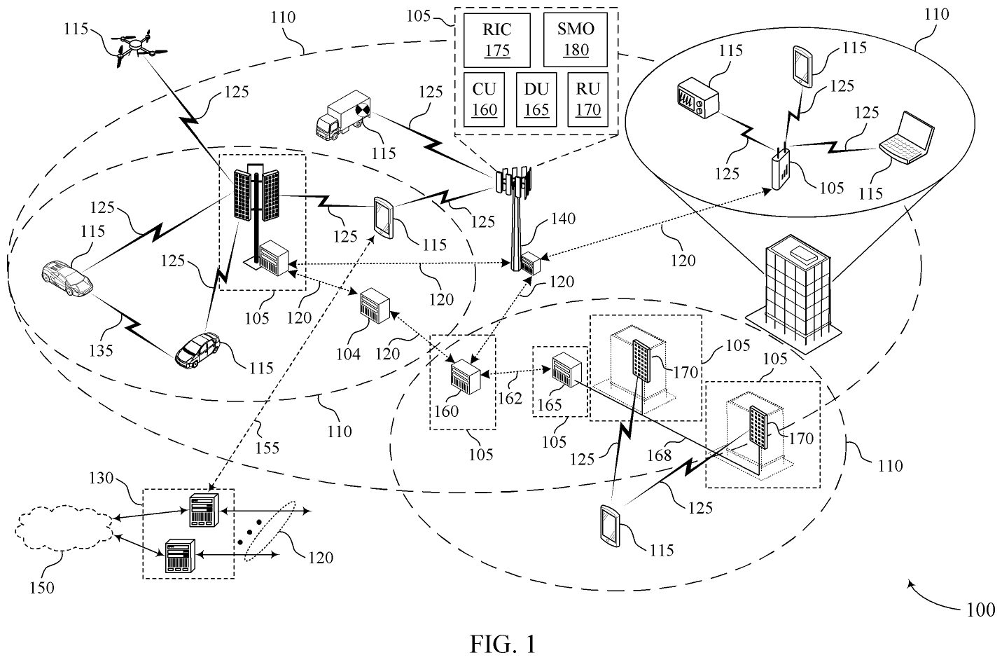

FIG. 1 illustrates an example of a wireless communications system 100 that supports waveform enhancement in backscatter communications in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a RF access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, may include disclosure of the UE 115, network entity 105, apparatus, device, computing system, being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support waveform enhancement in backscatter communications as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be positioned according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support concurrent communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. In an aspect, techniques disclosed herein may be applicable to MTC or IoT UEs. MTC or IoT UEs may include MTC/enhanced MTC (eMTC, also referred to as CAT-M, Cat M1) UEs, NB-IoT (also referred to as CAT NB1) UEs, as well as other types of UEs. eMTC and NB-IoT may refer to future technologies that may evolve from or may be based on these technologies. For example, eMTC may include FeMTC (further eMTC), eFeMTC (enhanced further eMTC), and mMTC (massive MTC), and NB-IoT may include eNB-IoT (enhanced NB-IoT), and FeNB-IoT (further enhanced NB-IoT).

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below: 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

Some wireless communication systems may provide support for passive UEs 115. A passive UE 115 may be a device that does not have a battery in the terminal and the terminal accumulates energy from radio signaling. Additionally or alternatively, the terminal may also accumulate energy from solar energy as a supplement. Passive UEs 115 may be advantageous in IoT applications due to their coverage capability, low power consumption, low cost, and positioning accuracy. For example, in some cases, the passive UE 115 may communicate at a distance of at least 30 meters such that the UE 115 may construct a feasible network coverage in a 5000 square meter warehouse. Additionally or alternatively, the passive UE 115 may utilize less than 0.1 milliwatt (mW) of power in order to operate without a battery. In some cases, the passive UE 115 may provide a relatively low cost to implement, which may be desirable in cost-sensitive applications. The passive UE 115 may be capable of performing positioning accuracy within three to five meters horizontally and vertically with 90% accuracy.

Due to a lack of battery, the passive UE 115 may communicate using backscattering techniques. Backscattering may be a technique in which a passive device may use RF signals to power up for data communications with an active device. Thus, a passive device may not have a power source, battery, or both, which may reduce power consumption and costs of the passive device. In some examples, passive devices in wireless communications system 100, may be continuously powered up by incident RF waves during communication. For example, the power from an electromagnetic signal (e.g., a waveform transmission) may be sufficient to activate the circuit of a passive device for one or more operations (e.g., transmitting, receiving, or reflecting signaling). In some cases, the passive device may charge a battery or temporarily power up using incident RF signals from an RF source (e.g., an RF reader), ambient RF signals from other transmissions, solar, thermal, light, or vibration energy harvesting techniques that may be implemented at the passive device, or any combination thereof.

The passive UE 115 may rely on received power to operate. Specifically, a RF source device may transmit a power-up signal that the UE 115 may receive and use as power for harvesting and backscattering. The UE 115 may partition the received power into absorbed power and reflected power, a majority of which may be absorbed power. In some cases, the UE 115 may experience a relatively small loss of the received power. The UE 115 may use the absorbed power for power harvesting, or powering of the UE integrated circuit (e.g., power rectifier, forward-link demodulation, logic, and memory). The UE 115 may use the reflected power for power backscattering (e.g., performing backscattering communications). Impedance matching between an antenna of the UE and the UE integrated circuit may control the amount of received power that is allocated for power harvesting or power backscattering. If there is an impedance mismatch between the antenna and the integrated circuit, an additional portion of the received power may be reflected and re-radiated by the antenna. In some cases, the UE 115 may use a relatively large amount of the received power for power harvesting in order to enable backscatter device modulation. However, the UE 115 may then be left with a smaller amount of received power for power backscattering, which may cause a lower SINR in the backscattered communications. Thus, in some cases it may be beneficial for the UE 115 to allocate a larger portion of the received power to backscattering and a smaller portion to harvesting. However, such partitioning of the received power may not be possible because the UE 115 may use a minimum amount of absorbed power for harvesting and a minimum amount of reflected power for backscattering. Thus, increasing the power available for backscattering may disable the functionality for performing data modulation.

Techniques described herein support utilization of CSS for passive UEs 115. CSS may refer to a technique that uses wideband linear frequency modulated chirp pulses to encode information. A chirp may refer to a sinusoidal signal whose frequency increases or decreases linearly over time. For example, a linear increase in frequency over time may be referred to as an upchirp, which may be used in uplink communications. A linear decrease in frequency over time may be referred to as a downchirp, which may be used in downlink communications. A CSS may use the entire allocated bandwidth to broadcast a signal, making CSS robust to channel noise. To support use of CSS in a passive UE 115, the passive UE 115 may be configured to apply a baseband frequency shift to encode the passive UE data onto a received waveform that is backscattered as a modulated CSS wave. Additionally, the passive UE 115 may be configured to signal when an amount of received power is enough to perform backscattering (e.g., the received power is greater than a threshold), and the passive UE may signaled to begin the backscattering communications.

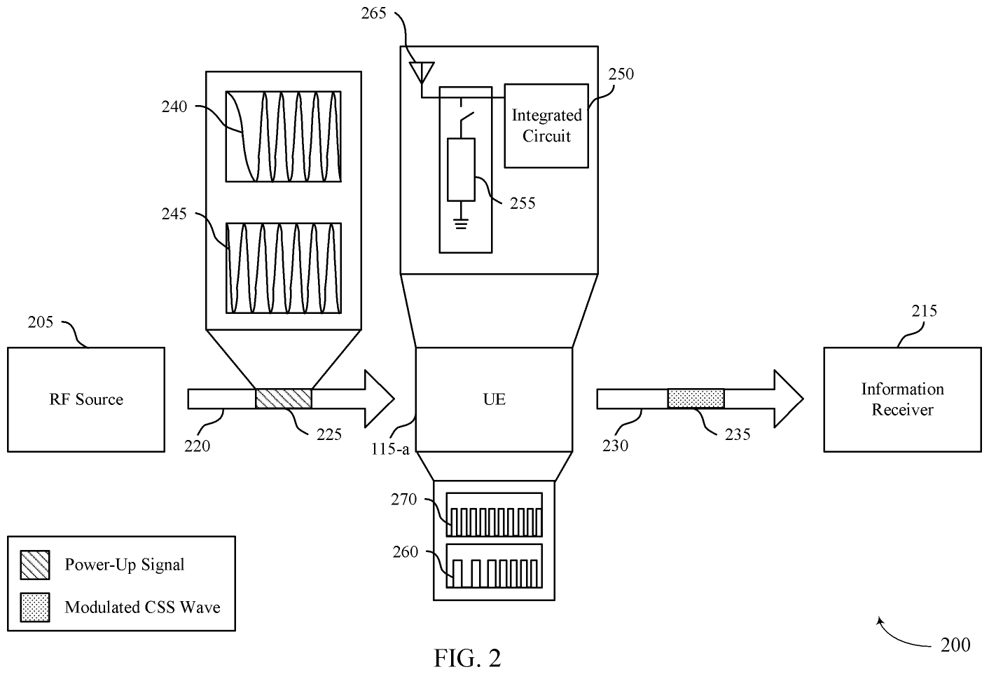

FIG. 2 illustrates an example of a wireless communications system 200 that supports waveform enhancement in backscatter communications in accordance with one or more aspects of the present disclosure. In particular, the wireless communications system 200 may implement or be implemented to realize aspects of the wireless communications system 100. For example, the wireless communications system 200 may illustrate communication between an RF source 205, a UE 115-a, and an information receiver 215. In a first implementation, the RF source 205 may be an example of a UE 115 as described in FIG. 1 and the information receiver 215 may be an example of a network entity 105 as described in FIG. 1. In a second implementation, the RF source 205 may be an example of a network entity 105 as described in FIG. 1 and the information receiver 215 may be an example of a network entity 105 as described in FIG. 1. In some examples, the RF source 205 and the information receiver 215 are both network entities 105 or both UEs 115. In other cases, the RF source 205 and the information receiver 215 are the same UE 115 or the same network entity 105. The techniques and methods described herein may apply to a single backscatter device or to multiple backscatter devices. Although a backscatter device (e.g., passive UE) may be represented as UE 115-a, which may be an example of UE 115 as described in FIG. 1, a backscatter device may not be limited to a UE implementation. For example, in other implementations a backscatter device may be a low-end device without RF (e.g., the UE may have a backscatter transmitter and envelope detector receiver), perform backscatter communications by modulating information on an incoming RF signal by adaption of an antenna load impedance, operate with energy harvesting from incoming radio waves (e.g., with or without a battery), perform ultra-low power consumption (e.g., 1 microwatt (uW) to 1000 uW), or any combination thereof. The RF source 205 may communicate with the UE 115-a over a power-up link 220 and the UE 115-a may communicate with the information receiver 215 over a backscatter link 230.

The UE 115-a may be an example of a passive UE that includes an antenna 265, a switch 255, and an integrated circuit 250. The integrated circuit 250 may include components such as a power rectifier, a forward-link demodulation component, additional logic, and memory among other circuitry components. The integrated circuit 250 may not have a component that generates power for an OFDM symbol or other independently generated communication signals. Instead, the UE 115-a may modulate data on a waveform received from the RF source 205 and reflect the received wave to the information receiver 215, and the reflected wave may carry data that is modulated onto the wave by the UE 115-a.

The switch 255 may alter the impedance matching between the antenna 265 and the integrated circuit 250. For example, the absorbed power (e.g., for power harvesting) may be determined as (1−|s|²)P_{received} and the reflected power (e.g., for backscatter communications) may be determined as α|s|²P_{received}, Where 0≤α≤1 is a loss parameter,

$${\vert s \vert}^{2} = {\vert \frac{{Z}_{L} - {Z}_{s}}{{Z}_{L} + {Z}_{S}} \vert}^{2} ,$$

Z_{L} is the impedance of the integrated circuit 250, and Z_{S} is the impedance of the antenna 265. When the impedance between the antenna 265 and the integrated circuit 250 is matched, the UE 115-a may operate with a lower reflected power (e.g., power to communicate). The switch 255 may alter the impedance matching between the antenna 265 and the integrated circuit 250 in order to increase the reflected power. However, increasing the reflected power may reduce the amount of received power available for power harvesting (e.g., operating the integrated circuit 250). If the UE 115-a does not have a sufficient amount of absorbed power, the UE 115-a may not be able to operate the integrated circuit 250 and thus may be unable to perform data modulation for backscatter communications.

As described herein, the UE 115-a may use a CSS modulated signal rather than increasing the reflected power by altering the impedance matching between the antenna 265 and the integrated circuit 250. CSS may be suitable for low SINR due to a high sensitivity achieved by using an efficient tradeoff between bandwidth and data rates when a signal experiences relatively high levels of noise (e.g., as low as −149 dBm). Additionally or alternatively, CSS may be suitable for in-band interference. For example, CSS may be resilient to fading and in-band interference. Specifically, CSS receivers may be able to decode data packets in the presence of a 95 dB higher out of band single tone interference.

In a first implementation, the RF source 205 may receive a message from the information receiver 215 that triggers the RF source 205 to continuously transmit a power-up signal 225 to the UE 115-a until the RF source 205 receives an indication from the information receiver 215 to stop transmitting the power-up signal 225. The power-up signal 225 may include a first radio frequency wave pattern which may be either a CSS waveform 240 or a carrier wave 245 of a constant frequency. The UE 115-a may harvest the energy received from the power-up signal 225 for operating the integrated circuit 250 and detect an envelope. When the UE 115-a has received sufficient energy to perform backscatter communications (e.g., satisfied a power threshold), the UE 115-a may send a completion message to the information receiver 215 indicating that the energy harvesting is complete. The completion message may be transmitted as a backscatter communication, which in some cases may in the form of a dedicated sequence or dedicated waveform.

The information receiver 215 may transmit control signaling to the RF source 205 which includes an indication of a UE identifier for the UE 115-a. The UE identifier may map the UE 115-a to a specific frequency shift, which may be predefined or configured at the UE 115-a. Additionally or alternatively, the information receiver 215 may assign a different frequency shift to each backscatter device (e.g., multiple UEs 115) of multiple backscatter devices (e.g., including UE 115-a). Accordingly, the control signaling may include an indication of a frequency shift index corresponding to the UE 115-a, where each index may map to a frequency shift. The RF source 205 may forward the UE identifier or frequency shift index to the UE 115-a, and the UE 115-a may determine a frequency shift to use for modulating data based on the received identifier or index.

The information receiver 215 may send a grant or group grant to the RF source 205 that includes resources for time domain multiplexing used in backscatter communications. The RF source 205 may forward the grant to the UE 115-a, if there is one backscatter device, or forward the group grant to each UE 115 if there are multiple backscatter devices. The RF source 205 may then send a power-up signal 225 to the UE 115-a, which includes either a CSS waveform 240 or a carrier wave 245 of a constant frequency. The switch 255 may alter the impedance of the integrated circuit 250 to generate a square wave 270, which the integrated circuit 250 may modulate with the CSS waveform 240 according to the baseband frequency shift received from the RF source 205. Additionally or alternatively, the switch 255 may alter the impedance of the integrated circuit 250 to generate a CSS square wave 260, which the integrated circuit 250 may modulate with the carrier wave 245 according to the baseband frequency shift received from the RF source 205. The UE 115-a may modulate that data on the received CSS waveform 240 or carrier wave 245 using frequency shift keying (FSK) and on-off keying (OOK), which will be described in further detail herein. The resulting modulated CSS wave 235, which may include data and a preamble, may be transmitted to the information receiver 215 over the backscatter link 230. The information receiver 215 may receive the modulated CSS wave 235 and subsequently de-spread and decode the encoded data, which will be described in further detail herein. If multiple backscatter devices (e.g., UEs 115) exist, the information receiver 215 may receive the modulated CSS wave 235 from each backscatter device concurrently.

In a second implementation, the RF source 205 may continuously transmit a power-up signal 225 to the UE 115-a. The power-up signal 225 may include a first radio frequency wave pattern which may be either a CSS waveform 240 or a carrier wave 245 of a constant frequency. The UE 115-a may harvest the energy received from the power-up signal 225 for operating the integrated circuit 250 and detect an envelope. When the UE 115-a has received sufficient energy to perform backscatter communications (e.g., satisfied a power threshold), the UE 115-a may send a completion message to the information receiver 215 indicating that the energy harvesting is complete. The completion message may be transmitted as a backscatter communication, which in some cases may be in the form of dedicated sequence or dedicated waveform. The information receiver 215 may forward the completion message to the RF source 205, which may trigger the RF source 205 to stop transmitting the power-up signal 225.

The RF source 205 may then transmit control signaling to the information receiver 215 and UE 115-a which includes an indication of a UE identifier for the UE 115-a. The UE identifier may map the UE 115-a to a specific frequency shift, which may be predefined. Additionally or alternatively, the RF source 205 may assign a different frequency shift to each backscatter device (e.g., UE 115) of multiple backscatter devices. Accordingly, the control signaling may include an indication of a frequency shift index corresponding to the UE 115-a, where each index may map to a frequency shift. The UE 115-a may determine a frequency shift to use for modulating data based on the received identifier or index.

The RF source 205 may send a grant or group grant to the UE 115-a and the information receiver 215 that includes resources for time domain multiplexing used in backscatter communications. The RF source 205 may then send a power-up signal 225 to the UE 115-a, which includes either a CSS waveform 240 or a carrier wave 245 of a constant frequency. The switch 255 may alter the impedance of the integrated circuit 250 to generate a square wave 270, which the integrated circuit 250 may modulate with the CSS waveform 240 according to the baseband frequency shift received from the RF source 205. Additionally or alternatively, the switch 255 may alter the impedance of the integrated circuit 250 to generate a CSS square wave 260, which the integrated circuit 250 may modulate with the carrier wave 245 according to the baseband frequency shift received from the RF source 205. The UE 115-a may modulate that data on the received CSS waveform 240 or carrier wave 245 using FSK and OOK, which will be described in further detail herein. The UE 115-a may transmit (e.g., signal or reflect) the resulting modulated CSS wave 235, which may include data and a preamble, to the information receiver 215 over the backscatter link 230. The information receiver 215 may receive the modulated CSS wave 235 and subsequently de-spread and decode the encoded data, which will be described in further detail herein. If multiple backscatter devices (e.g., UEs 115) exist, the information receiver 215 may receive the modulated CSS wave 235 from each backscatter device concurrently. The information receiver 215 may then forward the received data to the RF source 205.

The techniques described herein may be applied to one or multiple UEs 115. For example, the information receiver 215 may receive transmissions from multiple UEs concurrently and differentiate the multiple UEs by their baseband frequency shift. Using one or multiple UEs 115 may lead to various data rates as shown in Table 1.

TABLE 1
CSS backscattering multiplexing gain

| | | | Chirp | | | | |
|---|---|---|---|---|---|---|---|
| | | Spreading | Symbol | Data Rate for a | | Date Rate for | |
| Bandwidth | | Factor | Time | Single UE | | Multiple UEs | |
| 1 | MHz | 8 | 0.256 ms | 32 | Kbps | 1 | Mbps |
| 500 | kHz | 8 | 0.512 ms | 16 | Kbps | 500 | Kbps |
| 500 | kHz | 10 | 2.048 ms | 5 | Kbps | 500 | Kbps |
| 100 | kHz | 10 | 10.24 ms | 1 | Kbps | 100 | Kbps |

In a single UE backscattering implementation, there may be at most 2^{SF} different inputs in each chirp symbol period with 2^{SF} different frequency shifts, which may be equivalent to SF bits per chirp symbol period where SF is the spreading factor. Spreading factor may refer to the number of data bits that can be encoded in a chirp symbol. As such, the data rate using a single UE may be calculated as

$$S F * B W * \frac{1}{{2}^{SF}}$$

bps such that for each symbol duration, the UE 115-a backscatters SF bits with a power P.

In a multiple UE implementation, there may be at most 2^{SF} concurrent transmissions in each chirp symbol period with 2^{SF} different frequency shifts by 2^{SF} UEs. The data rate of each of the UEs may be calculated as

$$S F * B W * \frac{1}{{2}^{S F}} bps .$$

The backscattering power may be determined for each symbol duration as a maximum of 2^{SF} UEs backscatter 2^{SF} bits with each bit having a power P. As illustrated in Table 1, the data rate may be increased at most

$$\frac{{2}^{S F}}{S F}$$

times and the backscattering power may be increased approximately SF times, although each UE may experience a slightly different power P.

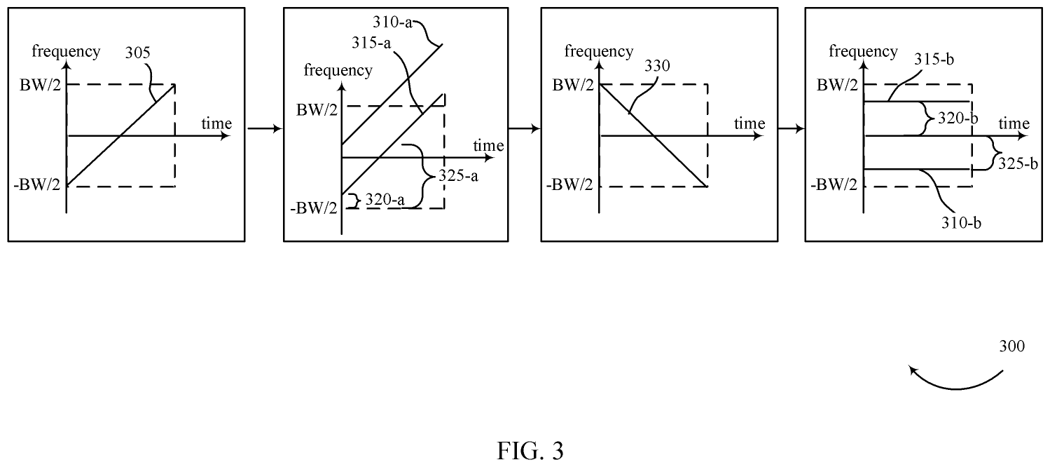

FIG. 3 illustrates an example of a FSK process that supports 300 that supports waveform enhancement in backscatter communications in accordance with one or more aspects of the present disclosure. The techniques described herein may be applied to the communication systems described in FIG. 1 and FIG. 2. For example, the RF source 205 may transmit a chirp symbol 305 (e.g., upchirp or downchirp symbol) to the UE 115-a as part of the power-up signal 225. The upchirp symbol 305 may be of length

$$\frac{1}{B W} * {2}^{S F}$$

where BW is the bandwidth of the upchirp symbol 305 and SF is the spreading factor.

The UE 115-a may perform TDM backscattering on each symbol of the received waveform 240. Specifically, the UE 115-a may perform FSK modulation on each symbol of the received waveform 240 such that a value may be indicated as switched on or switched off by a shifted frequency. For example, the UE 115-a may shift the upchirp symbol 305 by a frequency 320-a to create a shifted symbol 315-a, and the UE 115-a may shift the upchirp symbol 305 by a frequency 325-a to create a shifted symbol 310-a. Each shifted symbol may represent a binary value being switched on. For example, when the shifted symbol 310-a is present, the information receiver 215 may determine that a first binary value (e.g., binary zero) is switched on. Similarly, when the shifted symbol 315-a is present, the information receiver 215 may determine that a second binary value (e.g., binary one) is switched on. The UE 115-a may not be restricted to two shifted frequencies, however. Using FSK, the UE 115-a may generate a square wave with multiple frequencies indicating 0, 1, . . . , 2^{m}−1 different values for transmitting m bits where m is the modulation order.

The information receiver 215 may use a chirp symbol 330 (e.g., upchirp or downchirp symbol) received from the RF source 205 to decode the modulated CSS wave 235. The sampling rate may be the same as the bandwidth BW. The information receiver 215 may then perform de-spreading of the received symbols in which the information receiver 215 converts the shifted symbol 315-a to the symbol 315-b of a constant frequency 320-b and converts the shifted symbol 310-a to the symbol 310-b of a constant frequency 325-b. The frequency 325-b may be calculated as the difference between the bandwidth and the shifted frequency 325-a. The difference may be used to determine (e.g., decode) the data added by the backscatter device.

In some cases, performing FSK modulation of CSS symbols may be beneficial for signals with lower SINR because the information receiver 215 may detected an FSK modulated CSS symbol even when the signal experience significant levels of noise or in-band interference. However, in some cases FSK may cause the UE 115-a to switch on and off with two frequencies in each chirp symbol duration length.

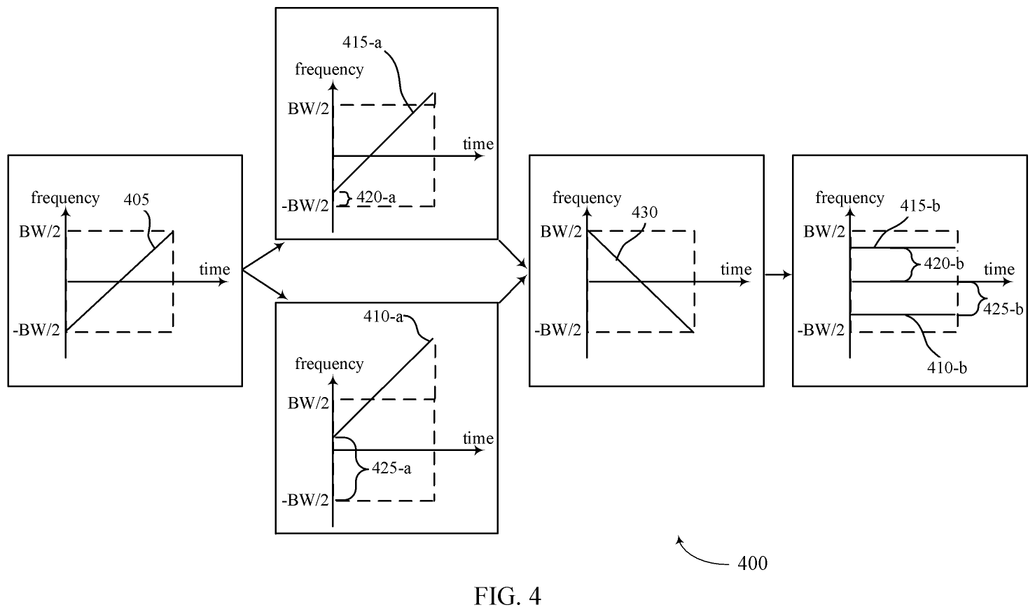

FIG. 4 illustrates an example of massive backscattering devices multiplexing 400 that supports waveform enhancement in backscatter communications in accordance with one or more aspects of the present disclosure. The techniques described herein may be applied to the communication systems described in FIG. 1 and FIG. 2. For example, the RF source 205 may transmit an upchirp symbol 405 to multiple UEs 115 as part of the power-up signal 225. The upchirp symbol 405 may be of length

$$\frac{1}{B W} * {2}^{S F}$$

where BW is the bandwidth of the upchirp symbol 405 and SF is the spreading factor. At most, 2^{SF} UEs may multiplex per chirp symbol.

When multiple UEs 115 are concurrently communicating with the information receiver 215, each UE 115 may be differentiated by a frequency shift. The RF source 205 may transmit a mapping to the information receiver 215 which associates a UE identifier with a frequency shift. The RF source 205 may transmit a similar mapping to each UE 115 as part of the power-up signal 225. Each UE 115 may use an OOK, meaning that the transmission of a shifted symbol may indicate one value (e.g., “1”) to the information receiver 215 while the absence of the shifted symbol may indicate a second value (e.g., “0”). For example, a first UE may be associated with a shift frequency 420-a. The first UE may communicate a first binary value (e.g., binary 0) by transmitting the shifted symbol 415-a and the first UE may communicate a second binary value (e.g., binary 1) by refraining from transmitting during the upchirp symbol slot. Likewise, a second UE may be associated with a shift frequency 425-a. The second UE may communicate a first binary value (e.g., binary 0) by transmitting the shifted symbol 410-a and the second UE may communicate a second binary value (e.g., binary 1) by refraining from transmitting during the upchirp symbol slot.

The information receiver 215 may use a downchirp symbol 430 received from the RF source 205 to decode the modulated CSS wave 235. The sampling rate may be the same as the bandwidth BW. The information receiver 215 may then perform de-spreading of the received symbols in which the information receiver 215 converts the shifted symbol 415-a of the first UE to the symbol 415-b of a constant frequency 420-b and converts the shifted symbol 410-a of the second UE to the symbol 410-b of a constant frequency 425-b. The frequency 425-b may be calculated as the difference between the bandwidth and the shifted frequency 425-a. The information receiver 215 may use the mapping provided by the RF source 205 to determine which data is associated with which UE. Additionally, the information receiver 215 may use the identified frequency shifts to decode the encoded data (e.g., the first and second values transmitted by respective UEs) from the received signal.

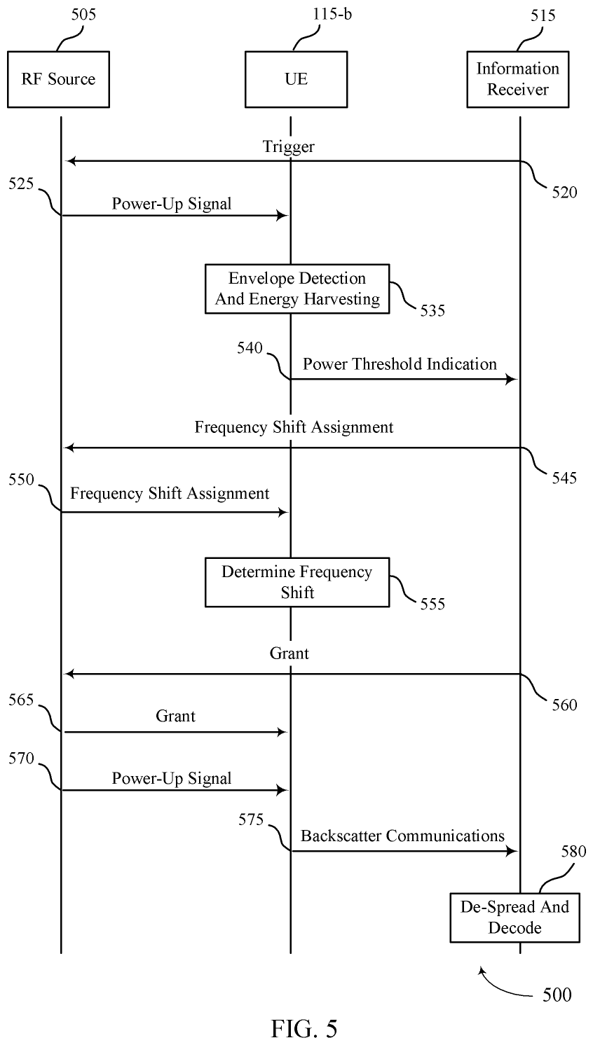

FIG. 5 illustrates an example of a process flow 500 that supports waveform enhancement in backscatter communications in accordance with one or more aspects of the present disclosure. In some examples, the process flow 500 may implement aspects of wireless communication systems 100 and the wireless communications systems 200 described with reference to FIGS. 1 and 2, respectively. For example, the process flow 500 may be implemented by a UE 115 as the source device 505, a network entity 105 as the network entity 515, and a passive UE 115-b as the backscatter device. The process flow 500 may be performed by a single UE as described with respect to FIG. 3. Additionally or alternatively, the process flow 500 may be performed by multiple UEs as described with respect to FIG. 4.

At 520, the source device 505 may receive, from a network entity 515, an indication to transmit a power-up wave signal to one or multiple backscatter devices including passive UE 115-b. The source device 505 may also receive, from the network entity 515, signaling indicating the first radio frequency wave pattern. In some cases, the network entity 515 may transmit the first radio frequency wave pattern as part of the indication of the power-up wave signal. In other cases, the network entity 515 may transmit the first radio frequency wave pattern separate from the power-up wave signal.

At 525, the passive UE 115-b may receive, from the source device 505, a power-up wave signal comprising a first radio frequency wave pattern. In some cases, the first radio frequency wave pattern may be a CSS wave. In other cases, the first radio frequency wave pattern may be a carrier wave of a constant frequency. The source device 505 may transmit the power-up wave signal until a condition is satisfied.

At 535, the passive UE 115-b may perform envelope detection and energy harvesting of the power received from the power-up signal. The passive UE 115-b may use a received power to operate its integrated circuit.

At 540, the passive UE 115-b may signal, to the network entity 515, an indication that the amount of power received via the power-up wave signal satisfies a received power threshold (e.g., enough energy harvested to perform processing). The passive UE 115-b may backscatter the indication to the network entity 515 as a dedicated sequence or dedicated waveform.

At 545, the source device 505 may receive, from the network entity 515, signaling indicating the baseband frequency shift that the passive UE 115-b is to use for one or more backscatter communications. At 550, the source device 505 may forward signaling indicating the baseband frequency shift to the passive UE 115-b based at least in part on receiving the signaling indicating the baseband frequency shift. In some cases, the signaling indicating the baseband frequency shift may be transmitted based at least in part on the signaling indicating that the amount of power satisfies the received power threshold. If the passive UE 115-b is performing backscatter communications individually, the frequency shift assignment may include a frequency shift index indication. If multiple UEs are performing backscatter communications, the frequency shift assignment may include a UE identification indication for the passive UE 115-b.

At 555, the passive UE 115-b may determine a baseband frequency shift to use in backscatter communications based on the received indication of an identifier associated with the passive UE 115-b, wherein the baseband frequency shift is determined based at least in part on the identifier.

At 560, source device 505 may receive, from a network entity 515, an indication that the passive UE 115-b is to signal the one or more backscatter communications. The indication may include a grant for resources for time domain multiplexing.

At 565, the source device 505 may transmit, to the passive UE 115-b based at least in part on receiving the indication that the passive UE 115-b is to signal, an indication that the passive UE 115-b is to signal the one or more backscatter communications. The indication may include a grant for one or more UEs to perform backscatter communications.

At 570, source device 505 may transmit a power-up signal to the passive UE 115-b such that the reflected power from the power-up signal may be used to perform backscatter communications. In some cases, the power-up signal may include a CSS wave. In other cases, the power-up signal may include a carrier wave of constant frequency.

At 575, the passive UE 115-b may signal, to a network entity 515, the one or more backscatter communications by frequency shifting the power-up wave signal according to the indicated baseband frequency shift and using a second radio frequency wave pattern, wherein one of the first radio frequency wave pattern or the second radio frequency wave pattern comprises a CSS pattern. For example, the passive UE 115-b may modulate a first value of data of the one or more backscatter communications using a first frequency shift value and a second value of data of the one or more backscatter communications using a second frequency shift value. At 580, the network entity 515 may decode the encoded data of the one or more backscatter communications based at least in part on the baseband frequency shift.

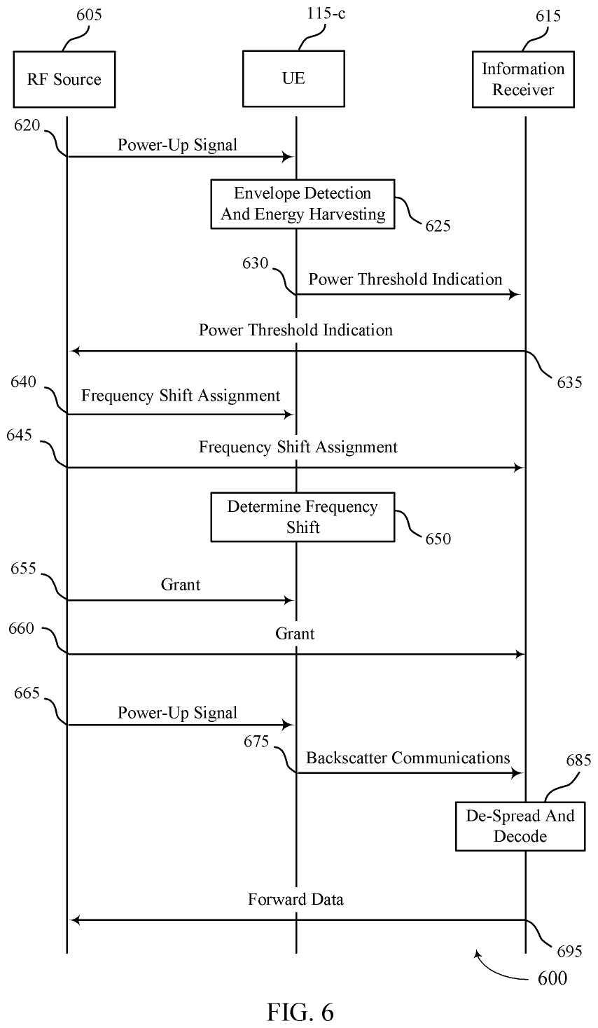

FIG. 6 illustrates an example of a process flow 600 that supports waveform enhancement in backscatter communications in accordance with one or more aspects of the present disclosure. In some examples, the process flow 600 may implement aspects of wireless communication systems 100 and the wireless communications systems 200 described with reference to FIGS. 1 and 2, respectively. For example, the process flow 600 may be implemented by a network entity 105 as the source device 605, a UE 115 as the receiver device 615, and a passive UE 115-c as the backscatter device. The process flow 600 may be performed by a single UE as described with respect to FIG. 3. Additionally or alternatively, the process flow 600 may be performed by multiple UEs as described with respect to FIG. 4.

At 620, the passive UE 115-c may receive, from a source device 605, a power-up wave signal comprising a first radio frequency wave pattern. In some cases, the first radio frequency wave pattern may be a CSS wave. In other cases, the first radio frequency wave pattern may be a carrier wave of a constant frequency.

At 625, the passive UE 115-c may perform envelope detection and energy harvesting on the power received from the power-up signal. Accordingly, the passive UE 115-c may use the received power to operate its integrated circuit.

At 630, the passive UE 115-c may signal, to the receiver device 615, an indication that an amount of power received via the power-up wave signal satisfies a received power threshold (e.g., enough energy harvested to perform processing). The passive UE 115-c may backscatter the indication as a dedicated sequence or dedicated waveform to the receiver device 615.

At 635, the source device 605 may receive a power threshold indication signaling from the receiver device 615 indicating that the passive UE 115-c harvested enough power to perform backscatter communications.

At 640, the passive UE 115-b may receive, from the source device 605, an indication of a identifier associated with the passive UE 115-b, wherein a baseband frequency shift is determined based at least in part on the identifier.

At 645, the source device 605 may transmit, to the receiver device 615, signaling indicating the baseband frequency shift that the passive UE 115-c is to use for the one or more backscatter communications.

At 650, the passive UE 115-c may determine a baseband frequency shift to use in backscatter communications based on the frequency shift assignment received from the source device 605. The passive UE 115-c may determine the frequency shift based on a frequency shift index (e.g., if one UE is present) or based on a UE identifier (e.g., if multiple UEs are present).

At 655, the source device 605 may transmit, to the passive UE 115-c, an indication that the passive UE is to signal the one or more backscatter communications. The indication may include a grant for resources for time domain multiplexing. At 660, the source device 605 may transmit, to the receiver device 615, signaling indicating that the passive UE 115-c is to signal the one or more backscatter communications.

At 665, source device 605 may transmit a power-up signal to the passive UE 115-c such that the reflected power from the power-up signal may be used to perform backscatter communications. In some cases, the power-up signal may be a CSS wave. In other cases, the power-up signal may be a carrier wave of constant frequency.

At 675, the passive UE 115-c may signal, to the receiver device 615, the one or more backscatter communications by frequency shifting the power-up wave signal according to the indicated baseband frequency shift and using a second radio frequency wave pattern, wherein one of the first radio frequency wave pattern or the second radio frequency wave pattern comprises a CSS pattern. For example, the passive UE 115-c may modulate a first value of data of the one or more backscatter communications using the first frequency shift value and a second value of data of the one or more backscatter communications using the second frequency shift value.

At 685, the receiver device 615 may decode the encoded data of the one or more backscatter communications based at least in part on the baseband frequency shift. At 695, the receiver device 615 may forward the received data to the source device 605.

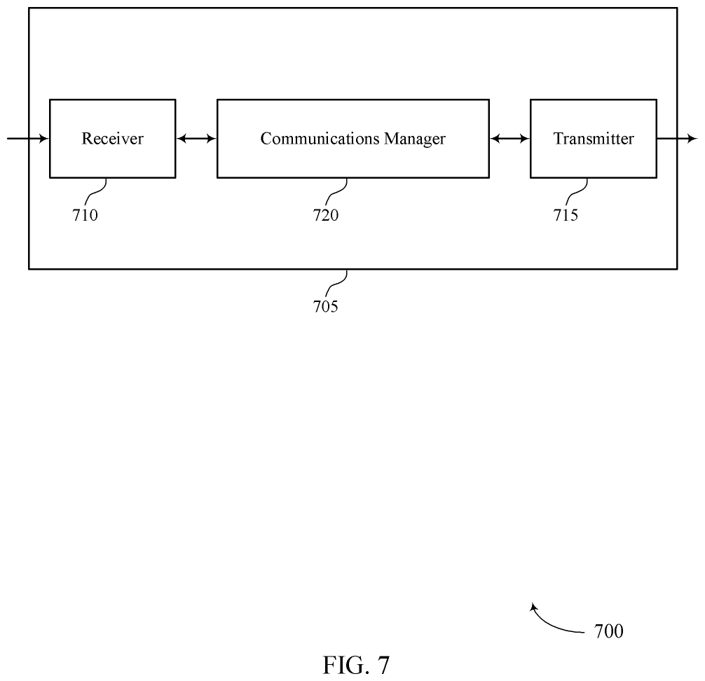

FIG. 7 shows a block diagram 700 of a device 705 that supports waveform enhancement in backscatter communications in accordance with one or more aspects of the present disclosure. The device 705 may be an example of aspects of a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to waveform enhancement in backscatter communications). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to waveform enhancement in backscatter communications). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of waveform enhancement in backscatter communications as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), a central processing unit (CPU), a graphics processing unit (GPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, at least one processor and memory coupled with the at least one processor may be configured to perform one or more of the functions described herein (e.g., by executing, by the at least one processor, instructions stored in the memory).

Additionally, or alternatively, in some examples, the communications manager 720, the receiver 710, the transmitter 715, or various combinations or components thereof may be implemented in code (e.g., as communications management software) executed by a processor. If implemented in code executed by a processor, the functions of the communications manager 720, the receiver 710, the transmitter 715, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications at a passive UE in accordance with examples as disclosed herein. For example, the communications manager 720 may be configured as or otherwise support a means for receiving signaling indicating a baseband frequency shift that the passive UE is to use for one or more backscatter communications. The communications manager 720 may be configured as or otherwise support a means for receiving, from a source device, a power-up wave signal including a first radio frequency wave pattern. The communications manager 720 may be configured as or otherwise support a means for signaling, to a receiver device, the one or more backscatter communications by frequency shifting the power-up wave signal according to the indicated baseband frequency shift and using a second radio frequency wave pattern, where one of the first radio frequency wave pattern or the second radio frequency wave pattern includes a chirp spread spectrum pattern.

Additionally, or alternatively, the communications manager 720 may support wireless communications at a source device in accordance with examples as disclosed herein. For example, the communications manager 720 may be configured as or otherwise support a means for transmitting, to a passive UE, signaling indicating a baseband frequency shift that the passive UE is to use for one or more backscatter communications. The communications manager 720 may be configured as or otherwise support a means for transmitting, to the passive UE, a power-up wave signal including a first radio frequency wave pattern, where the passive UE is configured to signal the one or more backscatter communications by frequency shifting the power-up wave signal according to the indicated baseband frequency shift and using a second radio frequency wave pattern, where one of the first radio frequency wave pattern or the second radio frequency wave pattern includes a chirp spread spectrum pattern.

Additionally, or alternatively, the communications manager 720 may support wireless communications at a receiver device in accordance with examples as disclosed herein. For example, the communications manager 720 may be configured as or otherwise support a means for receiving, from the passive UE, signaling including encoded data of the one or more backscatter communications. The communications manager 720 may be configured as or otherwise support a means for decoding the encoded data of the one or more backscatter communications based on a baseband frequency shift associated with communications by the passive UE.

By including or configuring the communications manager 720 in accordance with examples as described herein, the device 705 (e.g., a processor controlling or otherwise coupled with the receiver 710, the transmitter 715, the communications manager 720, or a combination thereof) may support techniques for reduced power consumption and more efficient utilization of communication resources.

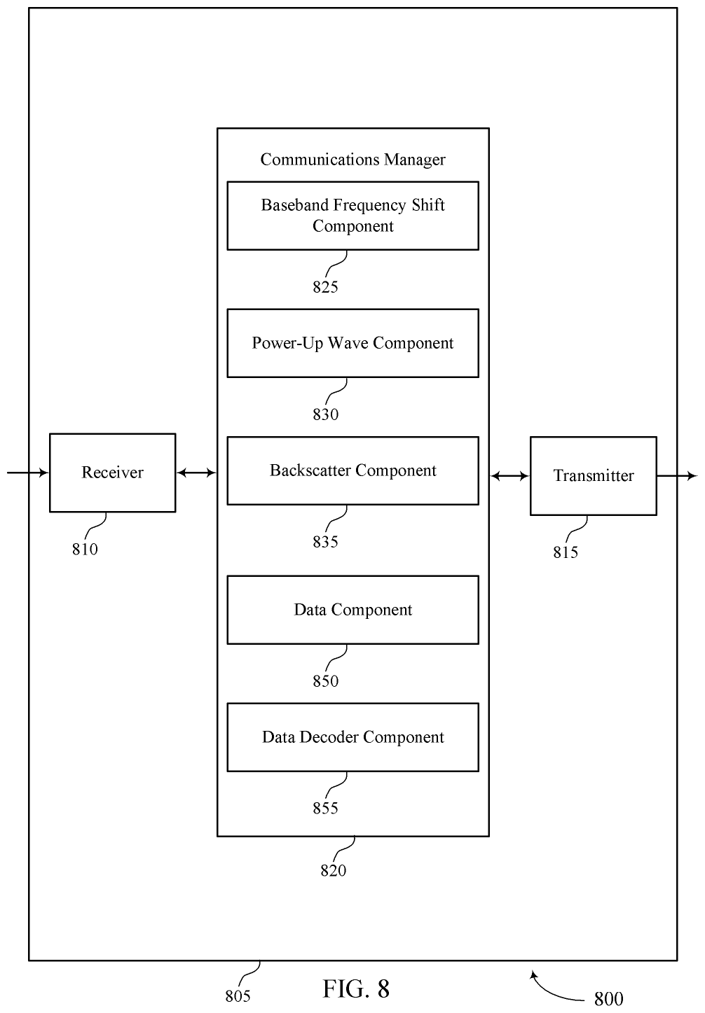

FIG. 8 shows a block diagram 800 of a device 805 that supports waveform enhancement in backscatter communications in accordance with one or more aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to waveform enhancement in backscatter communications). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to waveform enhancement in backscatter communications). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of waveform enhancement in backscatter communications as described herein. For example, the communications manager 820 may include a baseband frequency shift component 825, a power-up wave component 830, a backscatter component 835, a data component 850, a data decoder component 855, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications at a passive UE in accordance with examples as disclosed herein. The baseband frequency shift component 825 may be configured as or otherwise support a means for receiving signaling indicating a baseband frequency shift that the passive UE is to use for one or more backscatter communications. The power-up wave component 830 may be configured as or otherwise support a means for receiving, from a source device, a power-up wave signal including a first radio frequency wave pattern. The backscatter component 835 may be configured as or otherwise support a means for signaling, to a receiver device, the one or more backscatter communications by frequency shifting the power-up wave signal according to the indicated baseband frequency shift and using a second radio frequency wave pattern, where one of the first radio frequency wave pattern or the second radio frequency wave pattern includes a chirp spread spectrum pattern.

Additionally, or alternatively, the communications manager 820 may support wireless communications at a source device in accordance with examples as disclosed herein. The baseband frequency shift component 825 may be configured as or otherwise support a means for transmitting, to a passive UE, signaling indicating a baseband frequency shift that the passive UE is to use for one or more backscatter communications. The power-up wave component 830 may be configured as or otherwise support a means for transmitting, to the passive UE, a power-up wave signal including a first radio frequency wave pattern, where the passive UE is configured to signal the one or more backscatter communications by frequency shifting the power-up wave signal according to the indicated baseband frequency shift and using a second radio frequency wave pattern, where one of the first radio frequency wave pattern or the second radio frequency wave pattern includes a chirp spread spectrum pattern.

Additionally, or alternatively, the communications manager 820 may support wireless communications at a receiver device in accordance with examples as disclosed herein. The baseband frequency shift component 825 may be configured as or otherwise support a means for transmitting signaling indicating a baseband frequency shift that a passive UE is to use for one or more backscatter communications. The data component 850 may be configured as or otherwise support a means for receiving, from the passive UE, signaling including encoded data of the one or more backscatter communications. The data decoder component 855 may be configured as or otherwise support a means for decoding the encoded data of the one or more backscatter communications based on the baseband frequency shift associated with communications by the passive UE.

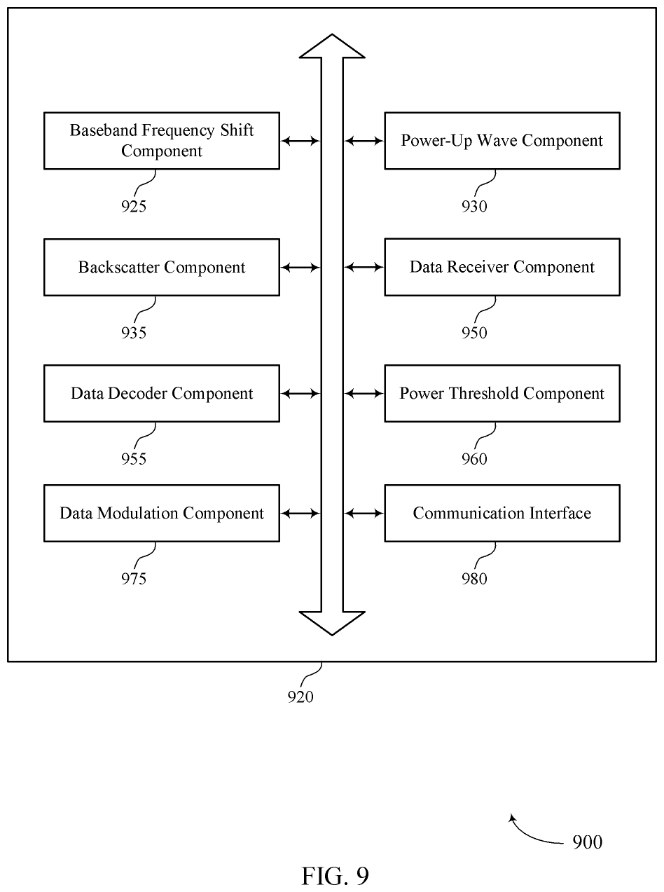

FIG. 9 shows a block diagram 900 of a communications manager 920 that supports waveform enhancement in backscatter communications in accordance with one or more aspects of the present disclosure. The communications manager 920 may be an example of aspects of a communications manager 720, a communications manager 820, or both, as described herein. The communications manager 920, or various components thereof, may be an example of means for performing various aspects of waveform enhancement in backscatter communications as described herein. For example, the communications manager 920 may include a baseband frequency shift component 925, a power-up wave component 930, a backscatter component 935, a data component 950, a data decoder component 955, a power threshold component 960, a data modulation component 975, a communication interface 980, or any combination thereof. Each of these components may communicate, directly or indirectly, with one another (e.g., via one or more buses).

The communications manager 920 may support wireless communications at a passive UE in accordance with examples as disclosed herein. The baseband frequency shift component 925 may be configured as or otherwise support a means for receiving signaling indicating a baseband frequency shift that the passive UE is to use for one or more backscatter communications. The power-up wave component 930 may be configured as or otherwise support a means for receiving, from a source device, a power-up wave signal including a first radio frequency wave pattern. The backscatter component 935 may be configured as or otherwise support a means for signaling, to a receiver device, the one or more backscatter communications by frequency shifting the power-up wave signal according to the indicated baseband frequency shift and using a second radio frequency wave pattern, where one of the first radio frequency wave pattern or the second radio frequency wave pattern includes a chirp spread spectrum pattern.

In some examples, the power threshold component 960 may be configured as or otherwise support a means for signaling, to the receiver device, an indication that an amount of power received via the power-up wave signal satisfies a received power threshold.

In some examples, to support receiving the signaling indicating the baseband frequency shift, the power threshold component 960 may be configured as or otherwise support a means for receiving the signaling based on a satisfaction of a received power threshold via power received via the power-up wave signal.

In some examples, to support receiving the signaling indicating the baseband frequency shift, the baseband frequency shift component 925 may be configured as or otherwise support a means for receiving an indication of a frequency shift value that the passive UE is to use for the one or more backscatter communications.

In some examples, to support signaling the one or more backscatter communications, the data modulation component 975 may be configured as or otherwise support a means for modulating a first value of data of the one or more backscatter communications using the frequency shift value and a second value of data of the one or more backscatter communications without using the frequency shift value.

In some examples, to support receiving the signaling indicating the baseband frequency shift, the baseband frequency shift component 925 may be configured as or otherwise support a means for receiving an indication of a first frequency shift value and a second frequency shift value that the passive UE is to use for the one or more backscatter communications.

In some examples, to support signaling the one or more backscatter communications, the data modulation component 975 may be configured as or otherwise support a means for modulating a first value of data of the one or more backscatter communications using the first frequency shift value and a second value of data of the one or more backscatter communications using the second frequency shift value.

In some examples, to support receiving the signaling indicating the baseband frequency shift, the baseband frequency shift component 925 may be configured as or otherwise support a means for receiving an indication of an identifier associated with the passive UE, where the baseband frequency shift is determined based on the identifier.

In some examples, the backscatter component 935 may be configured as or otherwise support a means for receiving, from the source device, signaling indicating that the passive UE is to signal the one or more backscatter communications, where the UE signals the one or more backscatter communications based on receiving the signaling.

In some examples, to support signaling the one or more backscatter communications, the data modulation component 975 may be configured as or otherwise support a means for modulating data of the one or more backscatter communications by frequency shifting the power-up wave signal in accordance with the baseband frequency shift and using the second radio frequency wave pattern.

In some examples, the first radio frequency wave pattern includes a chirp spread spectrum wave and the second radio frequency wave pattern includes a square wave.

In some examples, the first radio frequency wave pattern includes a carrier wave and the second radio frequency wave pattern includes a chirp spread spectrum square wave.

In some examples, the source device is a base station and the receiver device is a UE or the source device is the UE and the receiver device is the base station.

Additionally, or alternatively, the communications manager 920 may support wireless communications at a source device in accordance with examples as disclosed herein. The baseband frequency shift component 925 may be configured as or otherwise support a means for transmitting, to a passive UE, signaling indicating a baseband frequency shift that the passive UE is to use for one or more backscatter communications. The power-up wave component 930 may be configured as or otherwise support a means for transmitting, to the passive UE, a power-up wave signal including a first radio frequency wave pattern, where the passive UE is configured to signal the one or more backscatter communications by frequency shifting the power-up wave signal according to the indicated baseband frequency shift and using a second radio frequency wave pattern, where one of the first radio frequency wave pattern or the second radio frequency wave pattern includes a chirp spread spectrum pattern.

In some examples, the power-up wave component 930 may be configured as or otherwise support a means for receiving, from a network entity, an indication to transmit the power-up wave signal.

In some examples, the power-up wave component 930 may be configured as or otherwise support a means for receiving, from a network entity, signaling indicating the first radio frequency wave pattern.

In some examples, the power-up wave component 930 may be configured as or otherwise support a means for receiving, from a network entity, an indication to terminate transmission of the power-up wave signal. In some examples, the power-up wave component 930 may be configured as or otherwise support a means for stopping transmission of the power-up wave signal based on receiving the indication to terminate transmission.

In some examples, the baseband frequency shift component 925 may be configured as or otherwise support a means for receiving, from a network entity, signaling indicating the baseband frequency shift that the passive UE is to use for one or more backscatter communications, where the signaling indicating the baseband frequency shift is transmitted to the passive UE based on receiving the signaling indicating the baseband frequency shift.

In some examples, the backscatter component 935 may be configured as or otherwise support a means for receiving, from a network entity, an indication that the passive UE is to signal the one or more backscatter communications, where the power-up wave signal is transmitted based on receiving the indication.

In some examples, the backscatter component 935 may be configured as or otherwise support a means for transmitting, to the passive UE based on receiving the indication that the passive UE is to signal, an indication that the passive UE is to signal the one or more backscatter communications.

In some examples, the baseband frequency shift component 925 may be configured as or otherwise support a means for transmitting, to a second UE, signaling indicating the baseband frequency shift that the passive UE is to use for the one or more backscatter communications.

In some examples, the power threshold component 960 may be configured as or otherwise support a means for receiving, from a second UE, signaling indicating that an amount of power received, at the passive UE, via the power-up wave signal satisfies a received power threshold, where the signaling indicating the baseband frequency shift is transmitted based at least on the amount of power satisfying the received power threshold.

In some examples, to support transmitting the signaling indicating the baseband frequency shift, the baseband frequency shift component 925 may be configured as or otherwise support a means for transmitting an indication of a frequency shift value that the passive UE is to use for the one or more backscatter communications.

In some examples, to support transmitting the signaling indicating the baseband frequency shift, the baseband frequency shift component 925 may be configured as or otherwise support a means for transmitting an indication of a first frequency shift value and a second frequency shift value that the passive UE is to use for the one or more backscatter communications.

In some examples, to support transmitting the signaling indicating the baseband frequency shift, the baseband frequency shift component 925 may be configured as or otherwise support a means for transmitting an indication of a identifier associated with the passive UE.

In some examples, to support transmitting the signaling indicating the baseband frequency shift, the baseband frequency shift component 925 may be configured as or otherwise support a means for transmitting the identifier associated with the first passive UE and an identifier associated with a second passive UE.

In some examples, the backscatter component 935 may be configured as or otherwise support a means for transmitting, to the passive UE, a second UE, or both, signaling indicating that the passive UE is to signal the one or more backscatter communications.

In some examples, the source device is a network entity or a UE.

Additionally, or alternatively, the communications manager 920 may support wireless communications at a receiver device in accordance with examples as disclosed herein. In some examples, the baseband frequency shift component 925 may be configured as or otherwise support a means for transmitting signaling indicating a baseband frequency shift that a passive UE is to use for one or more backscatter communications. The data component 950 may be configured as or otherwise support a means for receiving, from the passive UE, signaling including encoded data of the one or more backscatter communications. The data decoder component 955 may be configured as or otherwise support a means for decoding the encoded data of the one or more backscatter communications based on the baseband frequency shift associated with communications by the passive UE.

In some examples, the power-up wave component 930 may be configured as or otherwise support a means for transmitting, to a source device, signaling indicating that the source device is to transmit a power-up wave signal including a first radio frequency wave pattern.

In some examples, the power threshold component 960 may be configured as or otherwise support a means for receiving, from the passive UE, signaling indicating that an amount of power received via a power-up wave signal satisfies a received power threshold, where the signaling indicating the baseband frequency shift is transmitted based on the signaling indicating that the amount of power satisfies the received power threshold.

In some examples, the power threshold component 960 may be configured as or otherwise support a means for transmitting, to a network entity, signaling indicating that the amount of power received, by the passive UE, satisfies the received power threshold.

In some examples, to support transmitting the signaling indicating the baseband frequency shift, the baseband frequency shift component 925 may be configured as or otherwise support a means for transmitting the signaling indicating a frequency shift value that the passive UE is to use for the one or more backscatter communications.

In some examples, to support transmitting the signaling indicating the baseband frequency shift, the baseband frequency shift component 925 may be configured as or otherwise support a means for transmitting the signaling indicating a first frequency shift value and a second frequency shift value that the passive UE is to use for the one or more backscatter communications.

In some examples, to support transmitting the signaling indicating the baseband frequency shift, the baseband frequency shift component 925 may be configured as or otherwise support a means for transmitting the signaling indicating a identifier associated with the passive UE.

In some examples, the power threshold component 960 may be configured as or otherwise support a means for transmitting, to a source device, signaling indicating that the source device is to terminate transmission of a power-up wave signal.

In some examples, the baseband frequency shift component 925 may be configured as or otherwise support a means for receiving, from a network entity, signaling indicating the baseband frequency shift that the passive UE is to use for one or more backscatter communications, where the signaling is transmitted to the passive UE based on receiving the signaling from the network entity.

In some examples, the data component 950 may be configured as or otherwise support a means for receiving, from a network entity, signaling indicating that the receiver device is to receive the one or more backscatter communications.

In some examples, the communication interface 980 may be configured as or otherwise support a means for transmitting, to a network entity, signaling that includes the data of the one or more backscatter communications.

In some examples, the receiver device is a network entity or a UE.

In some examples, the data of the one or more backscatter communications is encoded using a chirp spread spectrum pattern.

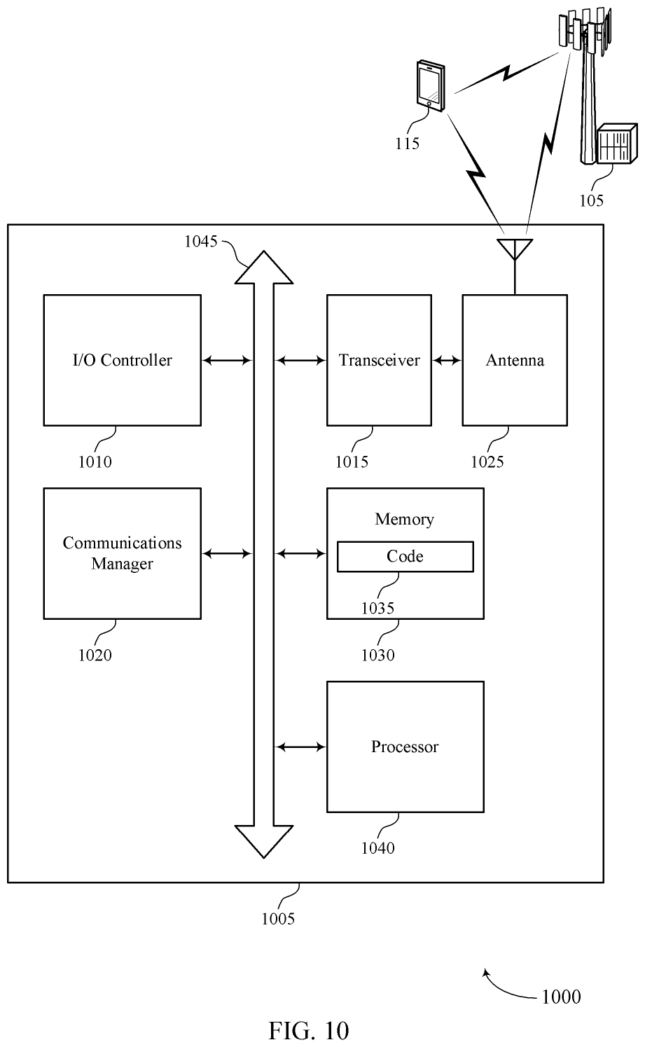

FIG. 10 shows a diagram of a system 1000 including a device 1005 that supports waveform enhancement in backscatter communications in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a GPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting waveform enhancement in backscatter communications). For example, the device 1005 or a component of the device 1005 may include a processor 1040 and memory 1030 coupled with or to the processor 1040, the processor 1040 and memory 1030 configured to perform various functions described herein.

The communications manager 1020 may support wireless communications at a passive UE in accordance with examples as disclosed herein. For example, the communications manager 1020 may be configured as or otherwise support a means for receiving signaling indicating a baseband frequency shift that the passive UE is to use for one or more backscatter communications. The communications manager 1020 may be configured as or otherwise support a means for receiving, from a source device, a power-up wave signal including a first radio frequency wave pattern. The communications manager 1020 may be configured as or otherwise support a means for signaling, to a receiver device, the one or more backscatter communications by frequency shifting the power-up wave signal according to the indicated baseband frequency shift and using a second radio frequency wave pattern, where one of the first radio frequency wave pattern or the second radio frequency wave pattern includes a chirp spread spectrum pattern.

Additionally, or alternatively, the communications manager 1020 may support wireless communications at a source device in accordance with examples as disclosed herein. For example, the communications manager 1020 may be configured as or otherwise support a means for transmitting, to a passive UE, signaling indicating a baseband frequency shift that the passive UE is to use for one or more backscatter communications. The communications manager 1020 may be configured as or otherwise support a means for transmitting, to the passive UE, a power-up wave signal including a first radio frequency wave pattern, where the passive UE is configured to signal the one or more backscatter communications by frequency shifting the power-up wave signal according to the indicated baseband frequency shift and using a second radio frequency wave pattern, where one of the first radio frequency wave pattern or the second radio frequency wave pattern includes a chirp spread spectrum pattern.

Additionally, or alternatively, the communications manager 1020 may support wireless communications at a receiver device in accordance with examples as disclosed herein. For example, the communications manager 1020 may be configured as or otherwise support a means for transmitting signaling indicating a baseband frequency shift that a passive UE is to use for one or more backscatter communications. The communications manager 1020 may be configured as or otherwise support a means for receiving, from the passive UE, signaling including encoded data of the one or more backscatter communications. The communications manager 1020 may be configured as or otherwise support a means for decoding the encoded data of the one or more backscatter communications based on the baseband frequency shift. associated with communications by the passive UE

By including or configuring the communications manager 1020 in accordance with examples as described herein, the device 1005 may support techniques for improved communication reliability, reduced power consumption, more efficient utilization of communication resources, improved coordination between devices, longer battery life, and improved utilization of processing capability.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of waveform enhancement in backscatter communications as described herein, or the processor 1040 and the memory 1030 may be otherwise configured to perform or support such operations.

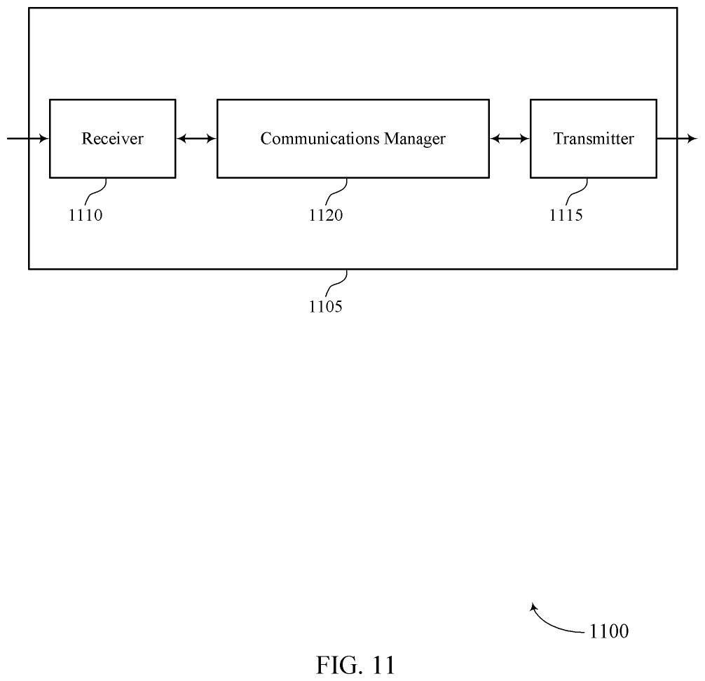

FIG. 11 shows a block diagram 1100 of a device 1105 that supports waveform enhancement in backscatter communications in accordance with one or more aspects of the present disclosure. The device 1105 may be an example of aspects of a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of waveform enhancement in backscatter communications as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a DSP, a CPU, a GPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1120, the receiver 1110, the transmitter 1115, or various combinations or components thereof may be implemented in code (e.g., as communications management software) executed by a processor. If implemented in code executed by a processor, the functions of the communications manager 1120, the receiver 1110, the transmitter 1115, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications at a source device in accordance with examples as disclosed herein. For example, the communications manager 1120 may be configured as or otherwise support a means for transmitting, to a passive UE, signaling indicating a baseband frequency shift that the passive UE is to use for one or more backscatter communications. The communications manager 1120 may be configured as or otherwise support a means for transmitting, to the passive UE, a power-up wave signal including a first radio frequency wave pattern, where the passive UE is configured to signal the one or more backscatter communications by frequency shifting the power-up wave signal according to the indicated baseband frequency shift and using a second radio frequency wave pattern, where one of the first radio frequency wave pattern or the second radio frequency wave pattern includes a chirp spread spectrum pattern.

Additionally, or alternatively, the communications manager 1120 may support wireless communications at a receiver device in accordance with examples as disclosed herein. For example, the communications manager 1120 may be configured as or otherwise support a means for transmitting signaling indicating a baseband frequency shift that a passive UE is to use for one or more backscatter communications. The communications manager 1120 may be configured as or otherwise support a means for receiving, from the passive UE, signaling including encoded data of the one or more backscatter communications. The communications manager 1120 may be configured as or otherwise support a means for decoding the encoded data of the one or more backscatter communications based on the baseband frequency shift associated with communications by the passive UE.

By including or configuring the communications manager 1120 in accordance with examples as described herein, the device 1105 (e.g., a processor controlling or otherwise coupled with the receiver 1110, the transmitter 1115, the communications manager 1120, or a combination thereof) may support techniques for reduced power consumption and more efficient utilization of communication resources.

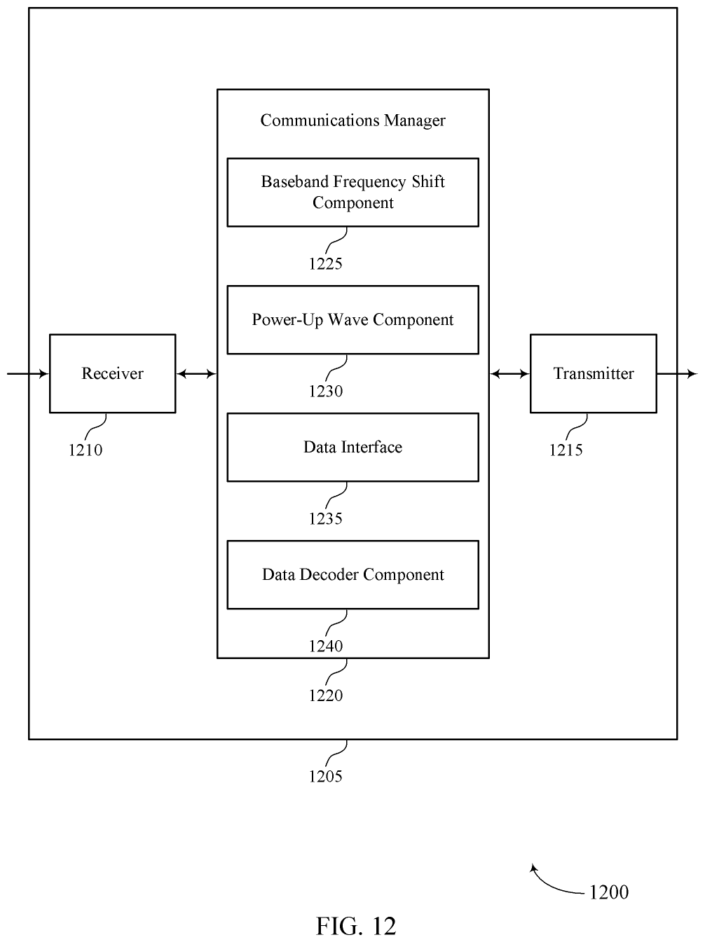

FIG. 12 shows a block diagram 1200 of a device 1205 that supports waveform enhancement in backscatter communications in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of waveform enhancement in backscatter communications as described herein. For example, the communications manager 1220 may include a baseband frequency shift component 1225, a power-up wave component 1230, a data interface 1235, a data decoder component 1240, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications at a source device in accordance with examples as disclosed herein. The baseband frequency shift component 1225 may be configured as or otherwise support a means for transmitting, to a passive UE, signaling indicating a baseband frequency shift that the passive UE is to use for one or more backscatter communications. The power-up wave component 1230 may be configured as or otherwise support a means for transmitting, to the passive UE, a power-up wave signal including a first radio frequency wave pattern, where the passive UE is configured to signal the one or more backscatter communications by frequency shifting the power-up wave signal according to the indicated baseband frequency shift and using a second radio frequency wave pattern, where one of the first radio frequency wave pattern or the second radio frequency wave pattern includes a chirp spread spectrum pattern.

Additionally, or alternatively, the communications manager 1220 may support wireless communications at a receiver device in accordance with examples as disclosed herein. The baseband frequency shift component 1225 may be configured as or otherwise support a means for transmitting signaling indicating a baseband frequency shift that a passive UE is to use for one or more backscatter communications. The data interface 1235 may be configured as or otherwise support a means for receiving, from the passive UE, signaling including encoded data of the one or more backscatter communications. The data decoder component 1240 may be configured as or otherwise support a means for decoding the encoded data of the one or more backscatter communications based on the baseband frequency shift associated with communications by the passive UE.

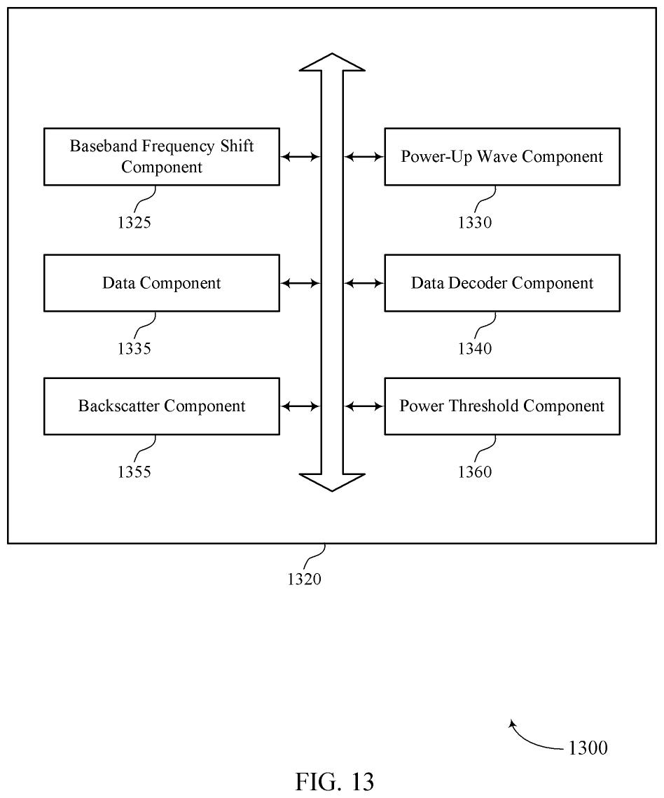

FIG. 13 shows a block diagram 1300 of a communications manager 1320 that supports waveform enhancement in backscatter communications in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of waveform enhancement in backscatter communications as described herein. For example, the communications manager 1320 may include a baseband frequency shift component 1325, a power-up wave component 1330, a data interface 1335, a data decoder component 1340, a backscatter component 1355, a power threshold component 1360, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communications at a source device in accordance with examples as disclosed herein. The baseband frequency shift component 1325 may be configured as or otherwise support a means for transmitting, to a passive UE, signaling indicating a baseband frequency shift that the passive UE is to use for one or more backscatter communications. The power-up wave component 1330 may be configured as or otherwise support a means for transmitting, to the passive UE, a power-up wave signal including a first radio frequency wave pattern, where the passive UE is configured to signal the one or more backscatter communications by frequency shifting the power-up wave signal according to the indicated baseband frequency shift and using a second radio frequency wave pattern, where one of the first radio frequency wave pattern or the second radio frequency wave pattern includes a chirp spread spectrum pattern.

In some examples, the power-up wave component 1330 may be configured as or otherwise support a means for receiving, from a network entity, an indication to transmit the power-up wave signal.

In some examples, the power-up wave component 1330 may be configured as or otherwise support a means for receiving, from a network entity, signaling indicating the first radio frequency wave pattern.

In some examples, the power-up wave component 1330 may be configured as or otherwise support a means for receiving, from a network entity, an indication to terminate transmission of the power-up wave signal. In some examples, the power-up wave component 1330 may be configured as or otherwise support a means for stopping transmission of the power-up wave signal based on receiving the indication to terminate transmission.

In some examples, the baseband frequency shift component 1325 may be configured as or otherwise support a means for receiving, from a network entity, signaling indicating the baseband frequency shift that the passive UE is to use for one or more backscatter communications, where the signaling indicating the baseband frequency shift is transmitted to the passive UE based on receiving the signaling indicating the baseband frequency shift.

In some examples, the backscatter component 1355 may be configured as or otherwise support a means for receiving, from a network entity, an indication that the passive UE is to signal the one or more backscatter communications, where the power-up wave signal is transmitted based on receiving the indication.

In some examples, the backscatter component 1355 may be configured as or otherwise support a means for transmitting, to the passive UE based on receiving the indication that the passive UE is to signal, an indication that the passive UE is to signal the one or more backscatter communications.

In some examples, the baseband frequency shift component 1325 may be configured as or otherwise support a means for transmitting, to a second UE, signaling indicating the baseband frequency shift that the passive UE is to use for the one or more backscatter communications.

In some examples, the power threshold component 1360 may be configured as or otherwise support a means for receiving, from a second UE, signaling indicating that an amount of power received, at the passive UE, via the power-up wave signal satisfies a received power threshold, where the signaling indicating the baseband frequency shift is transmitted based at least on the amount of power satisfying the received power threshold.

In some examples, to support transmitting the signaling indicating the baseband frequency shift, the baseband frequency shift component 1325 may be configured as or otherwise support a means for transmitting an indication of a frequency shift value that the passive UE is to use for the one or more backscatter communications.

In some examples, to support transmitting the signaling indicating the baseband frequency shift, the baseband frequency shift component 1325 may be configured as or otherwise support a means for transmitting an indication of a first frequency shift value and a second frequency shift value that the passive UE is to use for the one or more backscatter communications.

In some examples, to support transmitting the signaling indicating the baseband frequency shift, the baseband frequency shift component 1325 may be configured as or otherwise support a means for transmitting an indication of a identifier associated with the passive UE.

In some examples, to support transmitting the signaling indicating the baseband frequency shift, the baseband frequency shift component 1325 may be configured as or otherwise support a means for transmitting the identifier associated with the first passive UE and an identifier associated with a second passive UE.

In some examples, the backscatter component 1355 may be configured as or otherwise support a means for transmitting, to the passive UE, a second UE, or both, signaling indicating that the passive UE is to signal the one or more backscatter communications.

In some examples, the source device is a network entity or a UE.

Additionally, or alternatively, the communications manager 1320 may support wireless communications at a receiver device in accordance with examples as disclosed herein. In some examples, the baseband frequency shift component 1325 may be configured as or otherwise support a means for transmitting signaling indicating a baseband frequency shift that a passive UE is to use for one or more backscatter communications. The data interface 1335 may be configured as or otherwise support a means for receiving, from the passive UE, signaling including encoded data of the one or more backscatter communications. The data decoder component 1340 may be configured as or otherwise support a means for decoding the encoded data of the one or more backscatter communications based on the baseband frequency shift associated with communications by the passive UE.

In some examples, the power-up wave component 1330 may be configured as or otherwise support a means for transmitting, to a source device, signaling indicating that the source device is to transmit a power-up wave signal including a first radio frequency wave pattern.

In some examples, the power threshold component 1360 may be configured as or otherwise support a means for receiving, from the passive UE, signaling indicating that an amount of power received via a power-up wave signal satisfies a received power threshold, where the signaling indicating the baseband frequency shift is transmitted based on the signaling indicating that the amount of power satisfies the received power threshold.

In some examples, the power threshold component 1360 may be configured as or otherwise support a means for transmitting, to a network entity, signaling indicating that the amount of power received, by the passive UE, satisfies the received power threshold.

In some examples, to support transmitting the signaling indicating the baseband frequency shift, the baseband frequency shift component 1325 may be configured as or otherwise support a means for transmitting the signaling indicating a frequency shift value that the passive UE is to use for the one or more backscatter communications.

In some examples, to support transmitting the signaling indicating the baseband frequency shift, the baseband frequency shift component 1325 may be configured as or otherwise support a means for transmitting the signaling indicating a first frequency shift value and a second frequency shift value that the passive UE is to use for the one or more backscatter communications.

In some examples, to support transmitting the signaling indicating the baseband frequency shift, the baseband frequency shift component 1325 may be configured as or otherwise support a means for transmitting the signaling indicating a identifier associated with the passive UE.

In some examples, the power threshold component 1360 may be configured as or otherwise support a means for transmitting, to a source device, signaling indicating that the source device is to terminate transmission of a power-up wave signal.

In some examples, the baseband frequency shift component 1325 may be configured as or otherwise support a means for receiving, from a network entity, signaling indicating the baseband frequency shift that the passive UE is to use for one or more backscatter communications, where the signaling is transmitted to the passive UE based on receiving the signaling from the network entity.

In some examples, the data interface 1335 may be configured as or otherwise support a means for receiving, from a network entity, signaling indicating that the receiver device is to receive the one or more backscatter communications.

In some examples, the data interface 1335 may be configured as or otherwise support a means for transmitting, to a network entity, signaling that includes the data of the one or more backscatter communications.

In some examples, the receiver device is a network entity or a UE.

In some examples, the data of the one or more backscatter communications is encoded using a chirp spread spectrum pattern.

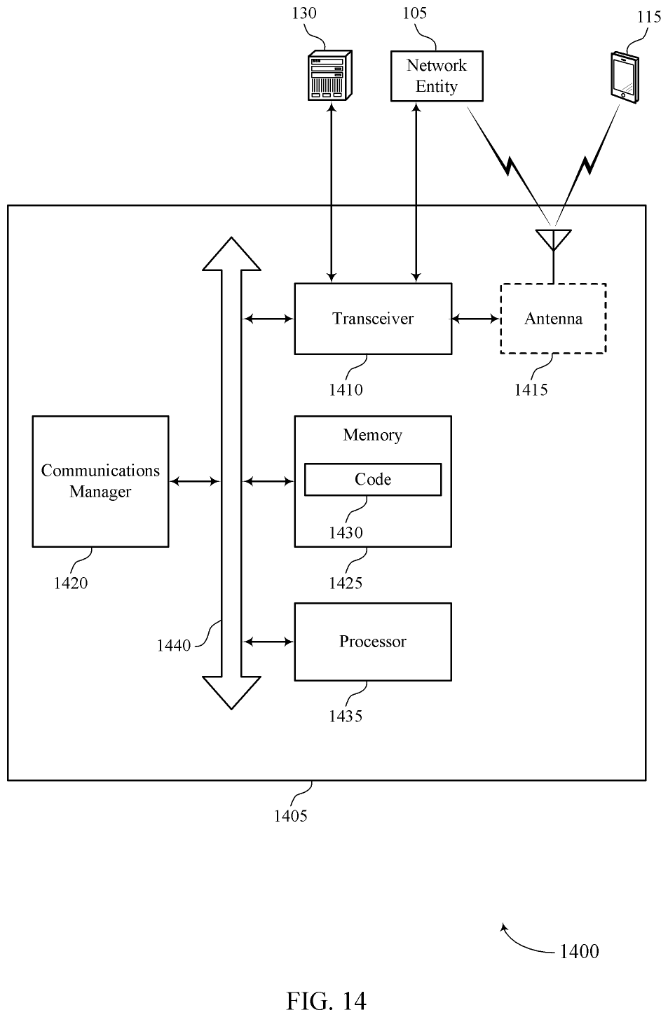

FIG. 14 shows a diagram of a system 1400 including a device 1405 that supports waveform enhancement in backscatter communications in accordance with one or more aspects of the present disclosure. The device 1405 may be an example of or include the components of a device 1105, a device 1205, or a network entity 105 as described herein. The device 1405 may communicate with one or more network entities 105, one or more UEs 115, or any combination thereof, which may include communications over one or more wired interfaces, over one or more wireless interfaces, or any combination thereof. The device 1405 may include components that support outputting and obtaining communications, such as a communications manager 1420, a transceiver 1410, an antenna 1415, a memory 1425, code 1430, and a processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. The transceiver 1410, or the transceiver 1410 and one or more antennas 1415 or wired interfaces, where applicable, may be an example of a transmitter 1115, a transmitter 1215, a receiver 1110, a receiver 1210, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1425 may include RAM and ROM. The memory 1425 may store computer-readable, computer-executable code 1430 including instructions that, when executed by the processor 1435, cause the device 1405 to perform various functions described herein. The code 1430 may be stored in a non-transitory computer-readable medium such as system memory or another type of memory. In some cases, the code 1430 may not be directly executable by the processor 1435 but may cause a computer (e.g., when compiled and executed) to perform functions described herein. In some cases, the memory 1425 may contain, among other things, a BIOS which may control basic hardware or software operation such as the interaction with peripheral components or devices.

The processor 1435 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1435 may be configured to operate a memory array using a memory controller. In some other cases, a memory controller may be integrated into the processor 1435. The processor 1435 may be configured to execute computer-readable instructions stored in a memory (e.g., the memory 1425) to cause the device 1405 to perform various functions (e.g., functions or tasks supporting waveform enhancement in backscatter communications). For example, the device 1405 or a component of the device 1405 may include a processor 1435 and memory 1425 coupled with the processor 1435, the processor 1435 and memory 1425 configured to perform various functions described herein. The processor 1435 may be an example of a cloud-computing platform (e.g., one or more physical nodes and supporting software such as operating systems, virtual machines, or container instances) that may host the functions (e.g., by executing code 1430) to perform the functions of the device 1405.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the memory 1425, the code 1430, and the processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105, and may include a controller or scheduler for controlling communications with UEs 115 in cooperation with other network entities 105. In some examples, the communications manager 1420 may support an X2 interface within an LTE/LTE-A wireless communications network technology to provide communication between network entities 105.

The communications manager 1420 may support wireless communications at a source device in accordance with examples as disclosed herein. For example, the communications manager 1420 may be configured as or otherwise support a means for transmitting, to a passive UE, signaling indicating a baseband frequency shift that the passive UE is to use for one or more backscatter communications. The communications manager 1420 may be configured as or otherwise support a means for transmitting, to the passive UE, a power-up wave signal including a first radio frequency wave pattern, where the passive UE is configured to signal the one or more backscatter communications by frequency shifting the power-up wave signal according to the indicated baseband frequency shift and using a second radio frequency wave pattern, where one of the first radio frequency wave pattern or the second radio frequency wave pattern includes a chirp spread spectrum pattern.

Additionally, or alternatively, the communications manager 1420 may support wireless communications at a receiver device in accordance with examples as disclosed herein. For example, the communications manager 1420 may be configured as or otherwise support a means for transmitting signaling indicating a baseband frequency shift that a passive UE is to use for one or more backscatter communications. The communications manager 1420 may be configured as or otherwise support a means for receiving, from the passive UE, signaling including encoded data of the one or more backscatter communications. The communications manager 1420 may be configured as or otherwise support a means for decoding the encoded data of the one or more backscatter communications based on the baseband frequency shift associated with communications by the passive UE.

By including or configuring the communications manager 1420 in accordance with examples as described herein, the device 1405 may support techniques for improved communication reliability, reduced latency, reduced power consumption, more efficient utilization of communication resources, and improved utilization of processing capability.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the processor 1435, the memory 1425, the code 1430, the transceiver 1410, or any combination thereof. For example, the code 1430 may include instructions executable by the processor 1435 to cause the device 1405 to perform various aspects of waveform enhancement in backscatter communications as described herein, or the processor 1435 and the memory 1425 may be otherwise configured to perform or support such operations.

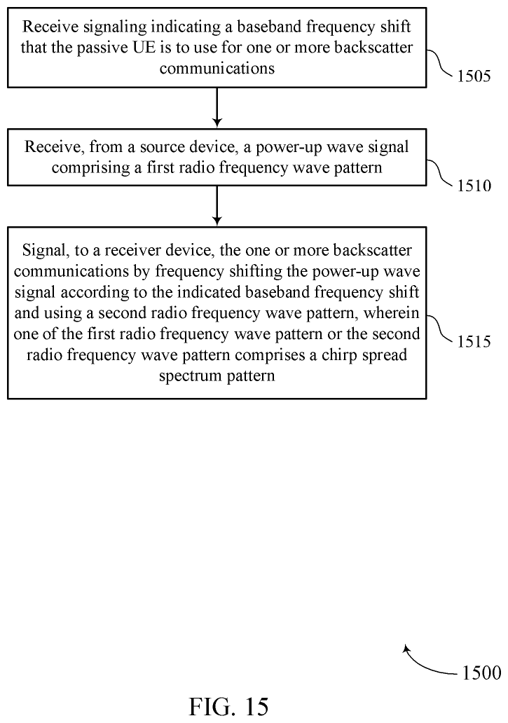

FIG. 15 shows a flowchart illustrating a method 1500 that supports waveform enhancement in backscatter communications in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving signaling indicating a baseband frequency shift that the passive UE is to use for one or more backscatter communications. The operations of 1505 may be performed in accordance with examples as disclosed herein. In some examples, aspects of the operations of 1505 may be performed by a baseband frequency shift component 925 as described with reference to FIG. 9.

At 1510, the method may include receiving, from a source device, a power-up wave signal including a first radio frequency wave pattern. The operations of 1510 may be performed in accordance with examples as disclosed herein. In some examples, aspects of the operations of 1510 may be performed by a power-up wave component 930 as described with reference to FIG. 9.

At 1515, the method may include signaling, to a receiver device, the one or more backscatter communications by frequency shifting the power-up wave signal according to the indicated baseband frequency shift and using a second radio frequency wave pattern, where one of the first radio frequency wave pattern or the second radio frequency wave pattern includes a chirp spread spectrum pattern. The operations of 1515 may be performed in accordance with examples as disclosed herein. In some examples, aspects of the operations of 1515 may be performed by a backscatter component 935 as described with reference to FIG. 9.

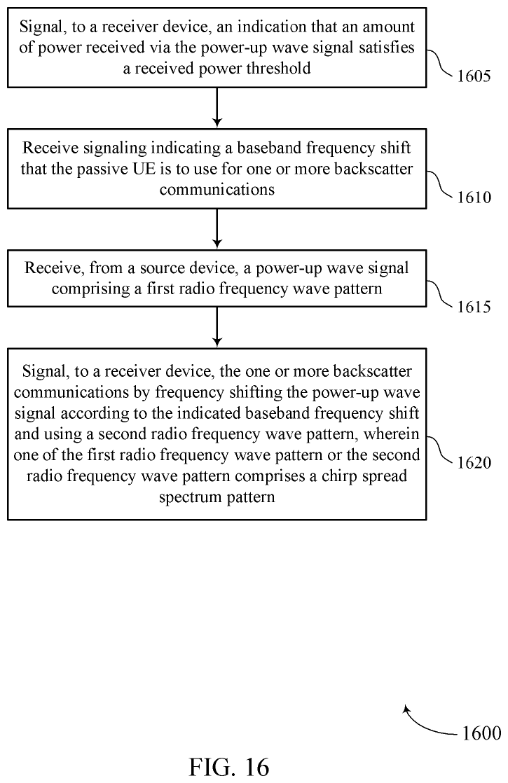

FIG. 16 shows a flowchart illustrating a method 1600 that supports waveform enhancement in backscatter communications in accordance with one or more aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include signaling, to a receiver device, an indication that an amount of power received via the power-up wave signal satisfies a received power threshold. The operations of 1605 may be performed in accordance with examples as disclosed herein. In some examples, aspects of the operations of 1605 may be performed by a power threshold component 960 as described with reference to FIG. 9.

At 1610, the method may include receiving signaling indicating a baseband frequency shift that the passive UE is to use for one or more backscatter communications. The operations of 1610 may be performed in accordance with examples as disclosed herein. In some examples, aspects of the operations of 1610 may be performed by a baseband frequency shift component 925 as described with reference to FIG. 9.

At 1615, the method may include receiving, from a source device, a power-up wave signal including a first radio frequency wave pattern. The operations of 1615 may be performed in accordance with examples as disclosed herein. In some examples, aspects of the operations of 1615 may be performed by a power-up wave component 930 as described with reference to FIG. 9.

At 1620, the method may include signaling, to a receiver device, the one or more backscatter communications by frequency shifting the power-up wave signal according to the indicated baseband frequency shift and using a second radio frequency wave pattern, where one of the first radio frequency wave pattern or the second radio frequency wave pattern includes a chirp spread spectrum pattern. The operations of 1620 may be performed in accordance with examples as disclosed herein. In some examples, aspects of the operations of 1620 may be performed by a backscatter component 935 as described with reference to FIG. 9.

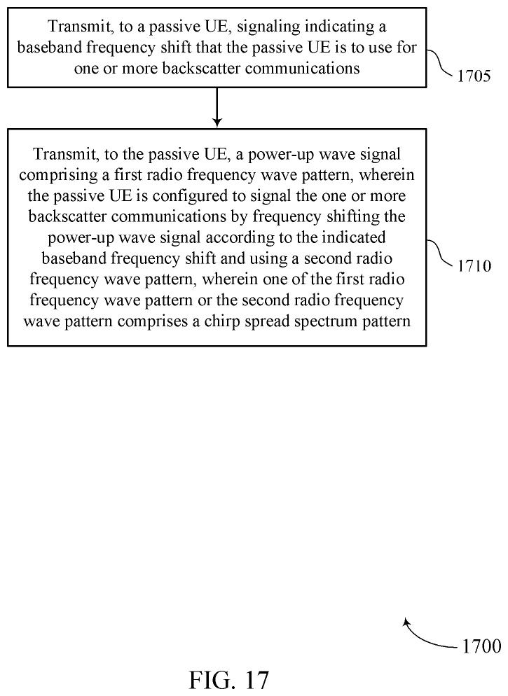

FIG. 17 shows a flowchart illustrating a method 1700 that supports waveform enhancement in backscatter communications in accordance with one or more aspects of the present disclosure. The operations of the method 1700 may be implemented by a UE or a network entity or its components as described herein. For example, the operations of the method 1700 may be performed by a UE 115 as described with reference to FIGS. 1 through 10 or a network entity as described with reference to FIGS. 1 through 6 and 11 through 14. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1705, the method may include transmitting, to a passive UE, signaling indicating a baseband frequency shift that the passive UE is to use for one or more backscatter communications. The operations of 1705 may be performed in accordance with examples as disclosed herein. In some examples, aspects of the operations of 1705 may be performed by a baseband frequency shift component 925 or a baseband frequency shift component 1325 as described with reference to FIGS. 9 and 13.

At 1710, the method may include transmitting, to the passive UE, a power-up wave signal including a first radio frequency wave pattern, where the passive UE is configured to signal the one or more backscatter communications by frequency shifting the power-up wave signal according to the indicated baseband frequency shift and using a second radio frequency wave pattern, where one of the first radio frequency wave pattern or the second radio frequency wave pattern includes a chirp spread spectrum pattern. The operations of 1710 may be performed in accordance with examples as disclosed herein. In some examples, aspects of the operations of 1710 may be performed by a power-up wave component 930 or a power-up wave component 1330 as described with reference to FIGS. 9 and 13.

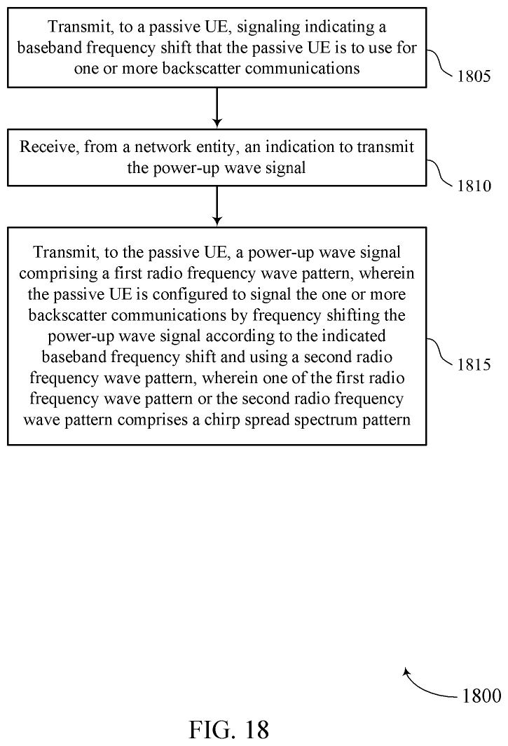

FIG. 18 shows a flowchart illustrating a method 1800 that supports waveform enhancement in backscatter communications in accordance with one or more aspects of the present disclosure. The operations of the method 1800 may be implemented by a UE or a network entity or its components as described herein. For example, the operations of the method 1800 may be performed by a UE 115 as described with reference to FIGS. 1 through 10 or a network entity as described with reference to FIGS. 1 through 6 and 11 through 14. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1805, the method may include transmitting, to a passive UE, signaling indicating a baseband frequency shift that the passive UE is to use for one or more backscatter communications. The operations of 1805 may be performed in accordance with examples as disclosed herein. In some examples, aspects of the operations of 1805 may be performed by a baseband frequency shift component 925 or a baseband frequency shift component 1325 as described with reference to FIGS. 9 and 13.

At 1810, the method may include receiving, from a network entity, an indication to transmit the power-up wave signal. The operations of 1810 may be performed in accordance with examples as disclosed herein. In some examples, aspects of the operations of 1810 may be performed by a power-up wave component 930 or a power-up wave component 1330 as described with reference to FIGS. 9 and 13.

At 1815, the method may include transmitting, to the passive UE, a power-up wave signal including a first radio frequency wave pattern, where the passive UE is configured to signal the one or more backscatter communications by frequency shifting the power-up wave signal according to the indicated baseband frequency shift and using a second radio frequency wave pattern, where one of the first radio frequency wave pattern or the second radio frequency wave pattern includes a chirp spread spectrum pattern. The operations of 1815 may be performed in accordance with examples as disclosed herein. In some examples, aspects of the operations of 1815 may be performed by a power-up wave component 930 or a power-up wave component 1330 as described with reference to FIGS. 9 and 13.

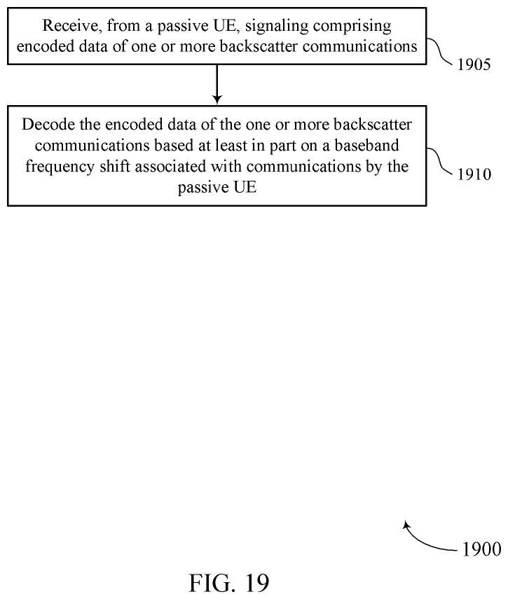

FIG. 19 shows a flowchart illustrating a method 1900 that supports waveform enhancement in backscatter communications in accordance with one or more aspects of the present disclosure. The operations of the method 1900 may be implemented by a UE or a network entity or its components as described herein. For example, the operations of the method 1900 may be performed by a UE 115 as described with reference to FIGS. 1 through 10 or a network entity as described with reference to FIGS. 1 through 6 and 11 through 14. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1905, the method may include receiving, from a passive UE, signaling including encoded data of one or more backscatter communications. The operations of 1905 may be performed in accordance with examples as disclosed herein. In some examples, aspects of the operations of 1905 may be performed by a data component 950 or a data interface 1335 as described with reference to FIGS. 9 and 13.

At 1910, the method may include decoding the encoded data of the one or more backscatter communications based at least in part on a baseband frequency shift associated with communications by the passive UE. The operations of 1910 may be performed in accordance with examples as disclosed herein. In some examples, aspects of the operations of 1910 may be performed by a data decoder component 955 or a data decoder component 1340 as described with reference to FIGS. 9 and 13.

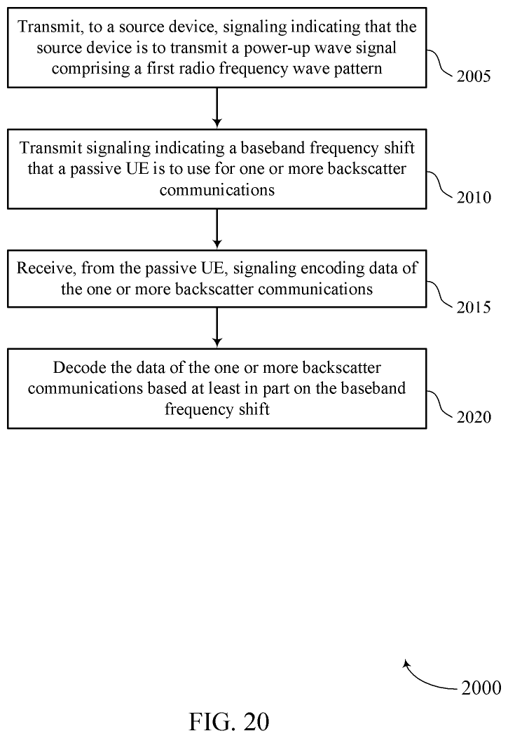

FIG. 20 shows a flowchart illustrating a method 2000 that supports waveform enhancement in backscatter communications in accordance with one or more aspects of the present disclosure. The operations of the method 2000 may be implemented by a UE or a network entity or its components as described herein. For example, the operations of the method 2000 may be performed by a UE 115 as described with reference to FIGS. 1 through 10 or a network entity as described with reference to FIGS. 1 through 6 and 11 through 14. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 2005, the method may include transmitting, to a source device, signaling indicating that the source device is to transmit a power-up wave signal including a first radio frequency wave pattern. The operations of 2005 may be performed in accordance with examples as disclosed herein. In some examples, aspects of the operations of 2005 may be performed by a power-up wave component 930 or a power-up wave component 1330 as described with reference to FIGS. 9 and 13.

At 2010, the method may include transmitting signaling indicating a baseband frequency shift that a passive UE is to use for one or more backscatter communications. The operations of 2010 may be performed in accordance with examples as disclosed herein. In some examples, aspects of the operations of 2010 may be performed by a baseband frequency shift component 925 or a baseband frequency shift component 1325 as described with reference to FIGS. 9 and 13.

At 2015, the method may include receiving, from the passive UE, signaling including encoded data of the one or more backscatter communications. The operations of 2015 may be performed in accordance with examples as disclosed herein. In some examples, aspects of the operations of 2015 may be performed by a data component 950 or a data interface 1335 as described with reference to FIGS. 9 and 13.

At 2020, the method may include decoding the encoded data of the one or more backscatter communications based at least in part on the baseband frequency shift. The operations of 2020 may be performed in accordance with examples as disclosed herein. In some examples, aspects of the operations of 2020 may be performed by a data decoder component 955 or a data decoder component 1340 as described with reference to FIGS. 9 and 13.

The following provides an overview of aspects of the present disclosure:

Aspect 1: A method for wireless communications at a passive UE, comprising: receiving signaling indicating a baseband frequency shift that the passive UE is to use for one or more backscatter communications: receiving, from a source device, a power-up wave signal comprising a first radio frequency wave pattern; and signaling, to a receiver device, the one or more backscatter communications by frequency shifting the power-up wave signal according to the indicated baseband frequency shift and using a second radio frequency wave pattern, wherein one of the first radio frequency wave pattern or the second radio frequency wave pattern comprises a chirp spread spectrum pattern.

Aspect 2: The method of aspect 1, further comprising: signaling, to the receiver device, an indication that an amount of power received via the power-up wave signal satisfies a received power threshold.

Aspect 3: The method of any of aspects 1 through 2, wherein receiving the signaling indicating the baseband frequency shift comprises: receiving the signaling based at least in part on a satisfaction of a received power threshold via power received via the power-up wave signal.

Aspect 4: The method of any of aspects 1 through 3, wherein receiving the signaling indicating the baseband frequency shift comprises: receiving an indication of a frequency shift value that the passive UE is to use for the one or more backscatter communications.

Aspect 5: The method of aspect 4, wherein signaling the one or more backscatter communications comprises: modulating a first value of data of the one or more backscatter communications using the frequency shift value and a second value of data of the one or more backscatter communications without using the frequency shift value.

Aspect 6: The method of any of aspects 1 through 5, wherein receiving the signaling indicating the baseband frequency shift comprises: receiving an indication of a first frequency shift value and a second frequency shift value that the passive UE is to use for the one or more backscatter communications.

Aspect 7: The method of aspect 6, wherein signaling the one or more backscatter communications comprises: modulating a first value of data of the one or more backscatter communications using the first frequency shift value and a second value of data of the one or more backscatter communications using the second frequency shift value.

Aspect 8: The method of any of aspects 1 through 7, wherein receiving the signaling indicating the baseband frequency shift comprises: receiving an indication of an identifier associated with the passive UE, wherein the baseband frequency shift is determined based at least in part on the identifier.

Aspect 9: The method of any of aspects 1 through 8, further comprising: receiving, from the source device, signaling indicating that the passive UE is to signal the one or more backscatter communications, wherein the UE signals the one or more backscatter communications based at least in part on receiving the signaling.

Aspect 10: The method of any of aspects 1 through 9, wherein signaling the one or more backscatter communications comprises: modulating data of the one or more backscatter communications by frequency shifting the power-up wave signal in accordance with the baseband frequency shift and using the second radio frequency wave pattern.

Aspect 11: The method of any of aspects 1 through 10, wherein the first radio frequency wave pattern comprises a chirp spread spectrum wave and the second radio frequency wave pattern comprises a square wave.

Aspect 12: The method of any of aspects 1 through 11, wherein the first radio frequency wave pattern comprises a carrier wave and the second radio frequency wave pattern comprises a chirp spread spectrum square wave.

Aspect 13: The method of any of aspects 1 through 12, wherein the source device is a network entity and the receiver device is a UE, or the source device is the UE and the receiver device is the network entity, the source device is a first network entity and the receiver device is a second network entity, the source device is a first UE and the receiver device is a second UE, the source device and the receiver device are the UE, or the source device and the receiver device are the network entity.

Aspect 14: A method for wireless communications at a source device, comprising: transmitting, to a passive UE, signaling indicating a baseband frequency shift that the passive UE is to use for one or more backscatter communications; and transmitting, to the passive UE, a power-up wave signal comprising a first radio frequency wave pattern, wherein the passive UE is configured to signal the one or more backscatter communications by frequency shifting the power-up wave signal according to the indicated baseband frequency shift and using a second radio frequency wave pattern, wherein one of the first radio frequency wave pattern or the second radio frequency wave pattern comprises a chirp spread spectrum pattern.

Aspect 15: The method of aspect 14, further comprising: receiving, from a network entity, an indication to transmit the power-up wave signal.

Aspect 16: The method of any of aspects 14 through 15, further comprising: receiving, from a network entity, signaling indicating the first radio frequency wave pattern.

Aspect 17: The method of any of aspects 14 through 16, further comprising: receiving, from a network entity, an indication to terminate transmission of the power-up wave signal; and stopping transmission of the power-up wave signal based at least in part on receiving the indication to terminate transmission.

Aspect 18: The method of any of aspects 14 through 17, further comprising: receiving, from a network entity, signaling indicating the baseband frequency shift that the passive UE is to use for one or more backscatter communications, wherein the signaling indicating the baseband frequency shift is transmitted to the passive UE based at least in part on receiving the signaling indicating the baseband frequency shift.

Aspect 19: The method of any of aspects 14 through 18, further comprising: receiving, from a network entity, an indication that the passive UE is to signal the one or more backscatter communications, wherein the power-up wave signal is transmitted based at least in part on receiving the indication.

Aspect 20: The method of aspect 19, further comprising: transmitting, to the passive UE based at least in part on receiving the indication that the passive UE is to signal, an indication that the passive UE is to signal the one or more backscatter communications.

Aspect 21: The method of any of aspects 14 through 20, further comprising: transmitting, to a second UE, signaling indicating the baseband frequency shift that the passive UE is to use for the one or more backscatter communications.

Aspect 22: The method of any of aspects 14 through 21, further comprising: receiving, from a second UE, signaling indicating that an amount of power received, at the passive UE, via the power-up wave signal satisfies a received power threshold, wherein the signaling indicating the baseband frequency shift is transmitted based at least on the amount of power satisfying the received power threshold.

Aspect 23: The method of any of aspects 14 through 22, wherein transmitting the signaling indicating the baseband frequency shift comprises: transmitting an indication of a frequency shift value that the passive UE is to use for the one or more backscatter communications.

Aspect 24: The method of any of aspects 14 through 23, wherein transmitting the signaling indicating the baseband frequency shift comprises: transmitting an indication of a first frequency shift value and a second frequency shift value that the passive UE is to use for the one or more backscatter communications.

Aspect 25: The method of any of aspects 14 through 24, wherein transmitting the signaling indicating the baseband frequency shift comprises: transmitting an indication of a identifier associated with the passive UE.

Aspect 26: The method of aspect 25, wherein the passive UE is a first passive UE and wherein transmitting the signaling indicating the baseband frequency shift comprises: transmitting the identifier associated with the first passive UE and an identifier associated with a second passive UE.

Aspect 27: The method of any of aspects 14 through 26, further comprising: transmitting, to the passive UE, a second UE, or both, signaling indicating that the passive UE is to signal the one or more backscatter communications.

Aspect 28: The method of any of aspects 14 through 27, wherein the source device is a network entity or a UE.

Aspect 29: A method for wireless communications at a receiver device, comprising: receiving, from the passive UE, signaling including encoded data of the one or more backscatter communications; and decoding the encoded data of the one or more backscatter communications based at least in part on a baseband frequency shift associated with communications by the passive UE.

Aspect 30: The method of aspect 29, further comprising: transmitting, to a source device, signaling indicating that the source device is to transmit a power-up wave signal comprising a first radio frequency wave pattern.

Aspect 31: The method of any of aspects 29 through 30, further comprising: receiving, from the passive UE, signaling indicating that an amount of power received via a power-up wave signal satisfies a received power threshold, wherein the signaling indicating the baseband frequency shift is transmitted based at least in part on the signaling indicating that the amount of power satisfies the received power threshold.

Aspect 32: The method of aspect 31, further comprising: transmitting, to a network entity, signaling indicating that the amount of power received, by the passive UE, satisfies the received power threshold.

Aspect 33: The method of any of aspects 29 through 32, wherein transmitting the signaling indicating the baseband frequency shift comprises: transmitting the signaling indicating a frequency shift value that the passive UE is to use for the one or more backscatter communications.

Aspect 34: The method of any of aspects 29 through 33, wherein transmitting the signaling indicating the baseband frequency shift comprises: transmitting the signaling indicating a first frequency shift value and a second frequency shift value that the passive UE is to use for the one or more backscatter communications.

Aspect 35: The method of any of aspects 29 through 34, wherein transmitting the signaling indicating the baseband frequency shift comprises: transmitting the signaling indicating a identifier associated with the passive UE.

Aspect 36: The method of any of aspects 29 through 35, further comprising: transmitting, to a source device, signaling indicating that the source device is to terminate transmission of a power-up wave signal.

Aspect 37: The method of any of aspects 29 through 36, further comprising: receiving, from a network entity, signaling indicating the baseband frequency shift that the passive UE is to use for one or more backscatter communications, wherein the signaling is transmitted to the passive UE based at least in part on receiving the signaling from the network entity.

Aspect 38: The method of any of aspects 29 through 37, further comprising: receiving, from a network entity, signaling indicating that the receiver device is to receive the one or more backscatter communications.

Aspect 39: The method of any of aspects 29 through 38, further comprising:

transmitting, to a network entity, signaling that includes the data of the one or more backscatter communications.

Aspect 40: The method of any of aspects 29 through 39, wherein the receiver device is a network entity or a UE.

Aspect 41: The method of any of aspects 29 through 40, wherein the data of the one or more backscatter communications is encoded using a chirp spread spectrum pattern.

Aspect 42: An apparatus for wireless communications at a passive UE, comprising at least one processor: memory coupled with the at least one processor, the memory storing instructions executable by the at least one processor to cause the passive UE to perform a method of any of aspects 1 through 13.

Aspect 43: An apparatus for wireless communications at a passive UE, comprising at least one means for performing a method of any of aspects 1 through 13.

Aspect 44: A non-transitory computer-readable medium storing code for wireless communications at a passive UE, the code comprising instructions executable by at least one processor to perform a method of any of aspects 1 through 13.

Aspect 45: An apparatus for wireless communications at a source device, comprising at least one processor, the memory storing instructions executable by the at least one processor to cause the source device to perform a method of any of aspects 14 through 28.

Aspect 46: An apparatus for wireless communications at a source device, comprising at least one means for performing a method of any of aspects 14 through 28.

Aspect 47: A non-transitory computer-readable medium storing code for wireless communications at a source device, the code comprising instructions executable by at least one processor to perform a method of any of aspects 14 through 28.

Aspect 48: An apparatus for wireless communications at a receiver device, comprising at least one processor, the memory storing instructions executable by the at least one processor to cause the receiver device to perform a method of any of aspects 29 through 41.

Aspect 49: An apparatus for wireless communications at a receiver device, comprising at least one means for performing a method of any of aspects 29 through 41.

Aspect 50: A non-transitory computer-readable medium storing code for wireless communications at a receiver device, the code comprising instructions executable by at least one processor to perform a method of any of aspects 29 through 41.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies, including future systems and radio technologies, not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (e.g., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone: B alone: C alone: A and B in combination: A and C in combination: B and C in combination; or A, B, and C in combination.

The term “determine” or “determining” encompasses a variety of actions and, therefore, “determining” can include calculating, computing, processing, deriving, investigating, looking up (such as via looking up in a table, a database or another data structure), or ascertaining. Also, “determining” can include receiving (such as receiving information) or accessing (such as accessing data in a memory). Also, “determining” can include resolving, obtaining, selecting, choosing, or establishing.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a passive user equipment (UE), comprising:
receiving signaling indicating a baseband frequency shift that the passive UE is to use for one or more backscatter communications;
receiving, from a source device, a power-up wave signal comprising a first radio frequency wave pattern; and
signaling, to a receiver device, the one or more backscatter communications by frequency shifting the power-up wave signal according to the indicated baseband frequency shift and using a second radio frequency wave pattern, wherein one of the first radio frequency wave pattern or the second radio frequency wave pattern comprises a chirp spread spectrum pattern.

2. The method of claim 1, further comprising:
signaling, to the receiver device, an indication that an amount of power received via the power-up wave signal satisfies a received power threshold.

3. The method of claim 1, wherein receiving the signaling indicating the baseband frequency shift comprises:
receiving the signaling based at least in part on a satisfaction of a received power threshold via power received via the power-up wave signal.

4. The method of claim 1, wherein receiving the signaling indicating the baseband frequency shift comprises:
receiving an indication of a frequency shift value that the passive UE is to use for the one or more backscatter communications.

5. The method of claim 4, wherein signaling the one or more backscatter communications comprises:
modulating a first value of data of the one or more backscatter communications using the frequency shift value and a second value of data of the one or more backscatter communications without using the frequency shift value.

6. The method of claim 1, wherein receiving the signaling indicating the baseband frequency shift comprises:
receiving an indication of a first frequency shift value and a second frequency shift value that the passive UE is to use for the one or more backscatter communications.

7. The method of claim 6, wherein signaling the one or more backscatter communications comprises:
modulating a first value of data of the one or more backscatter communications using the first frequency shift value and a second value of data of the one or more backscatter communications using the second frequency shift value.

8. The method of claim 1, wherein receiving the signaling indicating the baseband frequency shift comprises:
receiving an indication of a identifier associated with the passive UE, wherein the baseband frequency shift is determined based at least in part on the identifier.

9. The method of claim 1, further comprising:
receiving, from the source device, signaling indicating that the passive UE is to signal the one or more backscatter communications, wherein the UE signals the one or more backscatter communications based at least in part on receiving the signaling.

10. The method of claim 1, wherein signaling the one or more backscatter communications comprises:
modulating data of the one or more backscatter communications by frequency shifting the power-up wave signal in accordance with the baseband frequency shift and using the second radio frequency wave pattern.

11. The method of claim 1, wherein the first radio frequency wave pattern comprises a chirp spread spectrum wave and the second radio frequency wave pattern comprises a square wave.

12. The method of claim 1, wherein the first radio frequency wave pattern comprises a carrier wave and the second radio frequency wave pattern comprises a chirp spread spectrum square wave.

13. The method of claim 1, wherein the source device is a network entity and the receiver device is a UE, or the source device is the UE and the receiver device is the network entity, or the source device is a first network entity and the receiver device is a second network entity, or the source device is a first UE and the receiver device is a second UE, or the source device and the receiver device are the UE, or the source device and the receiver device are the network entity.

14. A method for wireless communications at a source device, comprising:
transmitting, to a passive user equipment (UE), signaling indicating a baseband frequency shift that the passive UE is to use for one or more backscatter communications; and
transmitting, to the passive UE, a power-up wave signal comprising a first radio frequency wave pattern, wherein the passive UE is configured to signal the one or more backscatter communications by frequency shifting the power-up wave signal according to the indicated baseband frequency shift and using a second radio frequency wave pattern, wherein one of the first radio frequency wave pattern or the second radio frequency wave pattern comprises a chirp spread spectrum pattern.

15. The method of claim 14, further comprising:
receiving, from a network entity, an indication to transmit the power-up wave signal.

16. The method of claim 14, further comprising:
receiving, from a network entity, signaling indicating the first radio frequency wave pattern.

17. The method of claim 14, further comprising:
receiving, from a network entity, and indication to terminate transmission of the power-up wave signal; and
stopping transmission of the power-up wave signal based at least in part on receiving the indication to terminate transmission.

18. The method of claim 14, further comprising:
receiving, from a network entity, signaling indicating the baseband frequency shift that the passive UE is to use for one or more backscatter communications, wherein the signaling indicating the baseband frequency shift is transmitted to the passive UE based at least in part on receiving the signaling indicating the baseband frequency shift.

19. The method of claim 14, further comprising:
receiving, from a network entity, an indication that the passive UE is to signal the one or more backscatter communications, wherein the power-up wave signal is transmitted based at least in part on receiving the indication.

20. The method of claim 19, further comprising:
transmitting, to the passive UE based at least in part on receiving the indication that the passive UE is to signal, an indication that the passive UE is to signal the one or more backscatter communications.

21. The method of claim 14, further comprising:
transmitting, to a second UE, signaling indicating the baseband frequency shift that the passive UE is to use for the one or more backscatter communications.

22. The method of claim 14, further comprising:
receiving, from a second UE, signaling indicating that an amount of power received, at the passive UE, via the power-up wave signal satisfies a received power threshold, wherein the signaling indicating the baseband frequency shift is transmitted based at least on the amount of power satisfying the received power threshold.

23. The method of claim 14, wherein transmitting the signaling indicating the baseband frequency shift comprises:
transmitting an indication of a frequency shift value that the passive UE is to use for the one or more backscatter communications.

24. The method of claim 14, wherein transmitting the signaling indicating the baseband frequency shift comprises:
transmitting an indication of a first frequency shift value and a second frequency shift value that the passive UE is to use for the one or more backscatter communications.

25. The method of claim 14, wherein transmitting the signaling indicating the baseband frequency shift comprises:
transmitting an indication of a identifier associated with the passive UE.

26. The method of claim 25, wherein the passive UE is a first passive UE and wherein transmitting the signaling indicating the baseband frequency shift comprises:
transmitting the identifier associated with the first passive UE and an identifier associated with a second passive UE.

27. The method of claim 14, further comprising:
transmitting, to the passive UE, a second UE, or both, signaling indicating that the passive UE is to signal the one or more backscatter communications.

28. The method of claim 14, wherein the source device is a network entity or a UE.

29. A method for wireless communications at a receiver device, comprising:
receiving, from a passive UE, signaling comprising encoded data of one or more backscatter communications; and
decoding the encoded data of the one or more backscatter communications based at least in part on a baseband frequency shift associated with communications by the passive UE.

30. An apparatus for wireless communications at a passive user equipment (UE), comprising:
at least one processor; and
memory coupled with the at least one processor, the memory storing instructions executable by the at least one processor to cause the passive UE to:
receive signaling indicating a baseband frequency shift that the passive UE is to use for one or more backscatter communications;
receive, from a source device, a power-up wave signal comprising a first radio frequency wave pattern; and
signal, to a receiver device, the one or more backscatter communications by frequency shifting the power-up wave signal according to the indicated baseband frequency shift and using a second radio frequency wave pattern, wherein one of the first radio frequency wave pattern or the second radio frequency wave pattern comprises a chirp spread spectrum pattern.
